(19) United States
(12) Patent Application Publication
(10) Pub. No.: US 2026/0046520 A1
(43) Pub. Date: Feb. 12, 2026

(54) ELECTRONIC DEVICE INCLUDING CAMERA, OPERATING METHOD THEREOF, AND RECORDING MEDIUM

(71) Applicant: Samsung Electronics Co., Ltd., Suwon-si (KR)

(72) Inventor: Hwayoung KANG, Suwon-si (KR)

(21) Appl. No.: 19/334,346

(22) Filed: Sep. 19, 2025

Related U.S. Application Data
(63) Continuation of application No. PCT/KR2025/011918, filed on Aug. 7, 2025.

(30) Foreign Application Priority Data
Aug. 11, 2024 (KR) 10-2024-0107248
Nov. 7, 2024 (KR) 10-2024-0156737

(51) Int. Cl. H04N 23/67; H04N 23/73; H04N 23/88; H04N 25/441; H04N 25/531

(52) U.S. Cl. CPC H04N 23/675; H04N 23/73; H04N 23/88; H04N 25/441; H04N 25/531

(57) ABSTRACT

An electronic device is provided. include a first camera module including a first image sensor. The electronic device may include at least one processor including a processing circuit. The electronic device may include a memory storing instructions. The electronic device may identify a first coordinate of a region of interest on the first image sensor. The electronic device may obtain a first control signal for obtaining image data including the region of interest. The electronic device may obtain first line data from a first pixel line including at least part of the region of interest, based on the first coordinate, among pixel lines of the first image sensor, in response to the first control signal. The electronic device may perform first image processing by using the first line data. The electronic device may obtain second line data from a second pixel line different from the first pixel line among the pixel lines of the first image sensor. The electronic device may perform second image processing by using the first line data and the second line data to obtain a first frame.

### CROSS-REFERENCE TO RELATED APPLICATION(S)

This application is a continuation application, claiming priority under 35 U.S.C. § 365 (c), of an International application No. PCT/KR2025/011918, filed on Aug. 7, 2025, which is based on and claims the benefit of a Korean patent application number 10-2024-0107248, filed on Aug. 11, 2024, in the Korean Intellectual Property Office, and of a Korean patent application number 10-2024-0156737, filed on Nov. 7, 2024, in the Korean Intellectual Property Office, the disclosure of each of which is incorporated by reference herein in its entirety.

### TECHNICAL FIELD

The disclosure relates to an electronic device including a camera, an operating method thereof, and a recording medium.

### BACKGROUND ART

With the development of digital technologies, various types of electronic devices, such as a mobile communication terminal, a Personal Digital Assistant (PDA), an electronic organizer, a smartphone, a tablet Personal Computer (PC), or a wearable device, are widely used. The electronic devices may provide various functions. For example, the electronic devices may execute at least one application in foreground and/or background to provide at least one function.

The electronic device may provide the various functions by using a designated operating system (e.g., Android™ operating system). For example, the electronic device may support a plurality of functions provided by using a camera.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of disclosure is to provide an electronic device including a camera, an operating method thereof, and a recording medium.

Additional aspects will be set forth in part in the description which follows and, in part, will be apparent from the description, or may be learned by practice of the presented embodiments.

In accordance with an aspect of the disclosure, an electronic device is provided. include a first camera module including a first image sensor. The electronic device may include at least one processor including a processing circuit. The electronic device may include a memory storing instructions. The electronic device may identify a first coordinate of a region of interest on the first image sensor. The electronic device may obtain a first control signal for obtaining image data including the region of interest. The electronic device may obtain first line data from a first pixel line including at least part of the region of interest, based on the first coordinate, among pixel lines of the first image sensor, in response to the first control signal. The electronic device may perform first image processing by using the first line data. The electronic device may obtain second line data from a second pixel line different from the first pixel line among the pixel lines of the first image sensor. The electronic device may perform second image processing by using the first line data and the second line data to obtain a first frame.

In accordance with an aspect of the disclosure, a method performed by an electronic device is provided. The operating method includes identifying a first coordinate of a region of interest on a first image sensor of a first camera module. The operating method may include obtaining a first control signal for obtaining image data including the region of interest. The operating method may include obtaining first line data from a first pixel line including at least part of the region of interest, based on the first coordinate, among pixel lines of the first image sensor, in response to the first control signal. The operating method may include performing first image processing by using the first line data. The operating method may include obtaining second line data from a second pixel line different from the first pixel line among the pixel lines of the first image sensor. The operating method may include performing second image processing by using the first line data and the second line data to obtain a first frame.

In accordance with an aspect of the disclosure, a computer-readable non-transitory recording medium in which instructions for controlling an electronic device according to an embodiment is provided. The recording medium may include an instruction for identifying a first coordinate of a region of interest on a first image sensor of a first camera module. The recording medium may include an instruction for obtaining a first control signal for obtaining image data including the region of interest. The recording medium may include an instruction for obtaining first line data from a first pixel line including at least part of the region of interest, based on the first coordinate, among pixel lines of the first image sensor, in response to the first control signal. The recording medium may include an instruction for performing first image processing by using the first line data. The recording medium may include an instruction for obtaining second line data from a second pixel line different from the first pixel line among the pixel lines of the first image sensor. The recording medium may include an instruction for performing second image processing by using the first line data and the second line data to obtain a first frame.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment, according to an embodiment of the disclosure;

FIG. 2 is a block diagram illustrating a camera module, according to an embodiment of the disclosure;

FIG. 3 is a block diagram illustrating a structure of an electronic device according to an embodiment of the disclosure;

FIG. 4 is a conceptual view illustrating a structure of an image sensor according to an embodiment of the disclosure;

FIG. 5 is a drawing for explaining a structure of an image sensor for obtaining an image through a rolling shutter method, according to an embodiment of the disclosure;

FIG. 6 is a drawing for explaining an operation of obtaining an image by an image sensor which obtains the image through a rolling shutter method, according to an embodiment of the disclosure;

FIG. 7 is a drawing for explaining an operation in which an electronic device controls a camera module by using an image obtained through a rolling shutter method, according to an embodiment of the disclosure;

FIG. 8 is a drawing for explaining a structure of an image sensor for obtaining an image through a global shutter method, according to an embodiment of the disclosure;

FIG. 9 is a drawing for explaining a sensor pixel of an image sensor which obtains an image through a global shutter method, according to an embodiment of the disclosure;

FIG. 10 is a drawing for explaining a sensor pixel of an image sensor which obtains an image through a global shutter method, according to an embodiment of the disclosure;

FIG. 11 is a drawing for explaining an operation of obtaining an image by an image sensor which obtains the image through a global shutter method, according to an embodiment of the disclosure;

FIG. 12 is a drawing for explaining an operation in which an electronic device controls a camera module by using an image obtained through a global shutter method, according to an embodiment of the disclosure;

FIG. 13 is a drawing for explaining data output from an image sensor which obtains an image through a global shutter method, according to an embodiment of the disclosure;

FIG. 14 is a drawing for explaining an artificial intelligence model used by an electronic device, according to an embodiment of the disclosure;

FIG. 15 is a drawing for explaining an operation in which an electronic device uses an artificial intelligence model to identify an object for a region of interest, according to an embodiment of the disclosure;

FIG. 16 is a flowchart of an operating method in which an electronic device obtains an image, according to an embodiment of the disclosure;

FIG. 17 is a flowchart of an operating method in which an electronic device obtains an image by using a plurality of camera modules, according to an embodiment of the disclosure; and

FIG. 18 is a drawing for explaining an operation in which an electronic device obtains an image by using a plurality of camera modules, according to an embodiment of the disclosure.

The same reference numerals are used to represent the same elements throughout the drawings.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An electronic device may use a camera module to capture a 2-dimensional or 3-dimensional image of an object. An image sensor of the camera module may create the image of the object by using a photoelectric conversion element which reacts depending on intensity of light reflected from the object.

The electronic device may set a region of interest on the image obtained using the camera module. The electronic device may control an Auto Focus (AF) operation of the camera module or may perform image processing, based on the region of interest.

The image sensor may include a plurality of pixel lines. The pixel line may include a line of the image sensor in which sensor pixels are arranged. The sensor pixel may include a unit of configuring the image sensor corresponding to a light receiving element.

The plurality of pixel lines may be sequentially exposed so that pixel values are sequentially read out. Such a method may be referred to as a rolling shutter method. The image sensor which creates the image through the rolling shutter method may sequentially expose pixel lines arranged from a first location (e.g., a top or bottom of the image sensor) to a second location (e.g., the bottom or top of the image sensor), and may read out pixel values.

The image sensor which creates the image through the roller shutter method may sequentially read out the pixel values from the pixel lines, irrespective of a location of a region of interest. Pixel values of the region of interest may be obtained fast or slowly depending on the location of the region of interest. A control of the AF operation of the camera module may be delayed or image processing may be delayed depending on the location of the region of interest.

Technical problems to be solved in the disclosure are not limited to the technical problems mentioned above, and other technical problems not mentioned herein may be clearly understood by those skilled in the art to which the disclosure pertains from the following descriptions.

Hereinafter, with reference to the attached drawings, embodiments are described in detail so as to be readily implemented by those skilled in the art to which the disclosure pertains. However, the disclosed embodiments may be realized in different forms and are not limited to the embodiments described herein.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

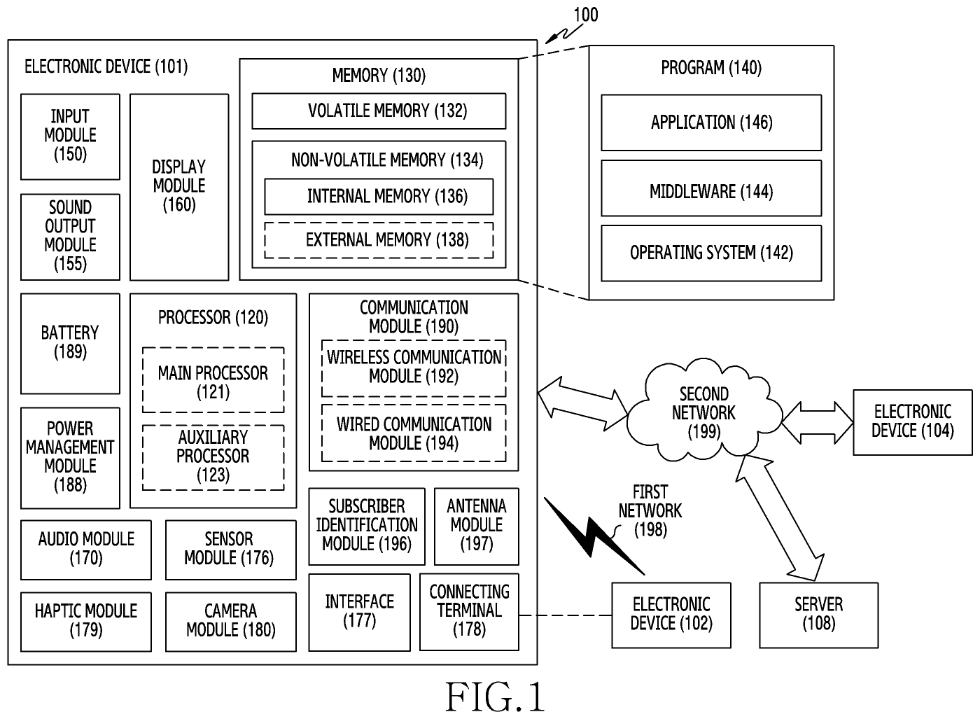

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., printed circuit board (PCB)). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

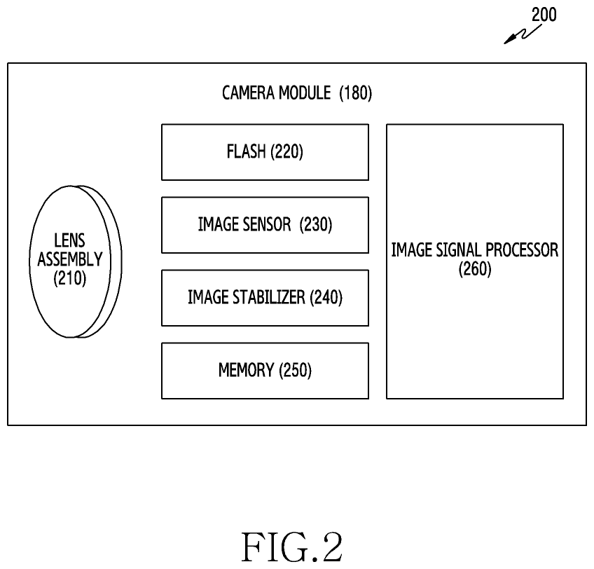

FIG. 2 is a block diagram of an electronic device 200 including a camera module 180, according to an embodiment of the disclosure.

Referring to FIG. 2, the camera module 180 may include a lens assembly 210, a flash 220, an image sensor 230, an image stabilizer 240, memory 250 (e.g., buffer memory), or an image signal processor 260.

The lens assembly 210 may collect light emitted or reflected from a subject of which an image is to be captured. The lens assembly 210 may include one or more lenses.

According to an embodiment, the camera module 180 may include the plurality of lens assemblies 210. In this case, the camera module 180 may constitute, for example, a dual camera, a 360-degree camera, or a spherical camera. Some of the plurality of lens assemblies 210 may have the same lens attribute (e.g., a field of view, a focal length, auto-focusing, f number, or optical zoom), or at least one lens assembly may have one or more lens attributes different from those of other lens assemblies. The lens assembly 210 may include, for example, a wide-angle lens or a telephoto lens.

The flash 220 may emit light which is used to reinforce light reflected from a subject. According to an embodiment, the flash 220 may include one or more Light Emitting Diodes (LEDs) (e.g., a Red-Green-Blue (RGB) LED, a white LED, an InfraRed (IR) LED, or an Ultra Violet (UV) LED) or a xenon lamp).

The image sensor 230 may obtain an image corresponding to the subject by converting light emitted or reflected from the subject and transmitted via the lens assembly 210 into an electrical signal. According to an embodiment, the image sensor 230 may include one image sensor selected from image sensors having different attributes, such as an RGB sensor, a Black-and-White (BW) sensor, an IR sensor, or a UV sensor, a plurality of image sensors having the same attribute, or a plurality of image sensors having different attributes. Each image sensor included in the image sensor 230 may be implemented using, for example, a Charged Coupled Device (CCD) sensor or a Complementary Metal Oxide Semiconductor (CMOS) sensor.

The image stabilizer 240 may move the image sensor 230 or at least one lens included in the lens assembly 210 in a particular direction, or control an operational feature (e.g., adjust a read-out timing) of the image sensor 230, in response to the movement of the camera module 180 or the electronic device 101 including the camera module 180. In doing so, at least part of a negative effect (e.g., image blurring) caused by the movement on an image being captured may be compensated for.

According to an embodiment, the image stabilizer 240 may sense the movement of the camera module 180 or electronic device 101 by using a gyro sensor (not shown) or acceleration sensor (not shown) disposed inside or outside the camera module 180. For example, the image stabilizer 240 may be implemented, for example, as an optic image stabilizer.

The memory 250 may store, at least temporarily, at least part of an image obtained using the image sensor 230 for a subsequent image processing task. For example, when image capturing is delayed depending on a shutter or when multiple images are quickly captured, an obtained raw image (e.g., a Bayer-patterned image, a high-resolution image) may be stored in the memory 250, and its corresponding copy image (e.g., a low-resolution image) may be previewed via the display device 160. Thereafter, if a specified condition is met (e.g., by a user's input or system command), at least part of the raw image stored in the memory 250 may be obtained and processed, for example, by the image signal processor 260. According to an embodiment, the memory 250 may be configured as at least part of the memory 130 or as separate memory which is operated independently from the memory 130.

According to an embodiment, the memory 250 may at least temporarily store images obtained and output as a preview image. The preview image may include an image provided by the electronic device 200 which makes it possible to validate a location, illumination, composition, or the like of an object to be captured so that a user is able to obtain a desired image.

The image signal processor 260 may perform at least one image processing with respect to an image obtained using the image sensor 230 or an image stored in the memory 250. The at least one image processing may include, for example, depth map generation, three-dimensional (3D) modeling, panorama generation, feature point extraction, image composition, or image compensation (e.g., noise reduction, resolution adjustment, brightness adjustment, blurring, sharpening, or softening). Additionally or alternatively, the image signal processor 260 may provide control (e.g., exposure time control or read-out timing control) to at least one (e.g., the image sensor 230) of the components included in the camera module 180. An image processed by the image signal processor 260 may be stored again in the memory 250 for further processing, or may be provided to an external component (e.g., the memory 130, the display device 160, the electronic device 102, the electronic device 104, or the server 108) of the camera module 180. According to an embodiment, the image signal processor 260 may be configured as at least part of the processor 120, or as a separate processor which is operated independently from the processor 120. If the image signal processor 260 is configured as a separate processor with respect to the processor 120, at least one image processed by the image signal processor 260 may be displayed by the processor 120 via the display device 160 as it is or after being further processed.

According to an embodiment, the electronic device 101 may include the plurality of camera modules 180 having different attributes or functions. For example, at least one of the plurality of camera modules 180 may be a wide-angle camera, and at least another one may be a telephoto camera. Similarly, at least one of the plurality of camera modules 180 may be a front camera, and at least another one may be a rear camera.

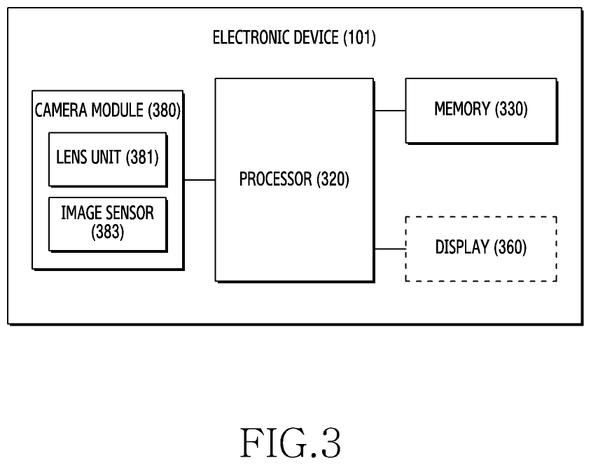

FIG. 3 is a block diagram illustrating a structure of an electronic device according to an embodiment of the disclosure.

Referring to FIG. 3, an electronic device 101 according to an embodiment may include a camera module 380, memory 330, and a processor 320. The electronic device 101 according to an embodiment may further include a display 360. The display 360 may be replaced with an external display coupled to the electronic device 101. The electronic device 101, the processor 320, the memory 330, the camera module 380, and the display 360 may respectively correspond to the electronic device 101, the processor 120, the memory 130, the camera module 180, and the display module 160 which are described above with reference to FIGS. 1 and 2. However, the components of the electronic device 101 of FIG. 3 are intended to explain an embodiment, and the electronic device 101 may include more components than the components of FIG. 3, or may include other components which may replace at least some of the components. For example, the memory 330 is not limited to a storage medium included in the electronic device 101, and may include a cloud storage outside the electronic device 101.

According to an embodiment, the camera module 380 may include a lens unit 381 (e.g., the lens assembly 210 of FIG. 2) including at least one lens for collecting light, and an image sensor 383 (e.g., the image sensor 230 of FIG. 2) which converts an optical signal passing through the lens unit 381 into a digital signal.

The image sensor 383 may include a color filter array including a plurality of light receiving elements, a plurality of micro lenses, and a plurality of color channels. The plurality of light receiving elements may include photo diodes arranged to correspond to one micro lens as an array having M rows and N columns. Herein, each of M and N may be a natural number greater than or equal to 1.

The color filter array included in the image sensor 383 may be configured with a non-Bayer pattern (e.g., a tetra pattern, a nona pattern, a hexa-deca pattern). Color of element groups of the color filter array configured with the non-Bayer pattern may be matched to correspond to a Bayer pattern.

According to an embodiment, the image sensor 383 may output an image signal (e.g., raw image data) configured with the non-Bayer pattern. For example, the image sensor 383 including the color filter array configured with the non-Bayer pattern may determine a pixel value by using an output value of a light receiving element corresponding to an element to output an image signal configured with the non-Bayer pattern. The image signal output from the image sensor 383 may be data in which a color pattern is maintained since a color order of a color pattern of the image sensor 383 is not changed.

According to an embodiment, the image sensor 383 may output an image signal (e.g., raw image data) configured with the Bayer pattern. For example, the image sensor 383 may output the image signal configured with the Bayer pattern, by binning output values of light receiving elements corresponding to an element group constituting a color filter array.

According to an embodiment, the image sensor 383 may operate in a high-resolution mode or a crop mode. The high-resolution mode may include a mode in which output values of light receiving elements included in the image sensor 383 are used as pixel values of pixels corresponding to the respective light receiving elements. In the disclosure, a ‘pixel’ may mean a minimum unit of configuring a digital image. A resolution of an image may be expressed by the number of pixels included in the image. For example, when the image is composed of ‘a’×‘b’ pixels arranged in ‘a’ rows and ‘b’ columns, the resolution of the image may be indicated as ‘a’×‘b’.

For example, the electronic device 101 may use the image sensor 383 composed of 50 Mp light receiving elements to use output values of the 50 Mp light receiving elements as pixel values of pixels corresponding to the respective light receiving elements, thereby obtaining high-resolution image data. The high-resolution mode may be understood as a full pixel mode.

The crop mode may include a mode in which output values of a specific number of light receiving elements (e.g., a specific number of light receiving elements located at a center portion of an image sensor) among the light receiving elements are used as pixel values. The electronic device 101 may obtain an image of which a Field of View (FOV) is narrowed through the crop mode, and may provide a user with an experience as if a zoom-in function operates. For example, when the electronic device 101 operates in the crop mode in which output values of 12.5 Mp light receiving elements located at a center of the image sensor 383 composed of 50 Mp light receiving elements are used as pixel values, the user may be provided with an experience as if a 2× zoom-in function operates.

According to an embodiment, the image sensor 383 may operate in a low-illumination mode or a multi-frame composition mode. The low-illumination mode may include a mode in which values output from first light receiving elements corresponding to elements of a color filter array matched with the same color of light receiving elements included in the image sensor 383 are used as pixel values of first pixels corresponding to the first light receiving elements. The multi-frame composition mode may include a mode in which the image sensor 383 obtains a plurality of frames having different exposure values.

According to an embodiment, the memory 330 may store instructions executable by the processor 320. The processor 320 may execute the instructions stored in the memory 330 to perform an operation or to control a component of the electronic device 101.

In the disclosure, the operation of the electronic device 101 may be understood as being performed when the at least one processor 320 executes instructions. According to an embodiment, the processor 320 may include an Application Processor (AP), a Central Processing Unit (CPU), an Image Signal Processor (ISP) (e.g., the image signal processor 260 of FIG. 2), a Graphical Processing Unit (GPU), and/or a Neural Processing Unit (NPU). For example, the at least one processor 320 may include the application processor. The at least one processor 320 may obtain image data, based on an image frame including information read out from the image sensor 383.

According to an embodiment, the at least one processor 320 may execute a camera application to control the camera module 380. For example, the processor 320 may use the camera application to initiate an operation of the camera module 380. For example, the processor 320 may use the camera application to provide the camera module 380 a request for obtaining at least one frame (e.g., a frame for preview, a frame for capture). For example, the processor 320 may use the camera application to obtain one or more frames. For example, the processor 320 may identify a user input received using the camera application (e.g., a user input for obtaining a capture image). For example, the processor 320 may use the camera application to obtain image data (e.g., preview image data, draft image data, capture image data, moving-picture data). For example, the processor 320 may display the obtained image data by using the display 360.

According to an embodiment, the at least one processor 320 may transmit a control signal to the image sensor 383 to perform a readout operation. For example, the at least one processor 320 may transmit a control signal, based on a designated communication scheme (e.g., Inter-Integrated Circuit (I2C), Improved Inter-Integrated Circuit (I3C)). The at least one processor 320 may obtain image data output from the image sensor 383. The image data may include an image frame. For example, the at least one processor 320 may receive the image data through an interface (e.g., a Mobile Industry Processor Interface (MIPI)) coupled to the image sensor 383.

According to an embodiment, the at least one processor 320 may control the image sensor 383 to obtain an image corresponding to a user input. The processor 320 may control the image sensor 383 to operate based on a selected capture mode. For example, the image sensor 383 may output an image signal (e.g., raw image data) by reading out respective outputs of light receiving elements constituting the image sensor 383 to correspond to pixels corresponding to the respective light receiving elements, based on a first capture mode (e.g., a high-resolution capture mode). For example, the image sensor 383 may output the image signal (e.g., the raw image data) by reading out respective outputs of a specific number of first light receiving elements among a plurality of light receiving elements to correspond to pixels corresponding to the respective first light receiving elements, based on a second capture mode (e.g., a crop capture mode). For example, the image sensor 383 may output the image signal (e.g., the raw image data) by reading out an output of a first group including a plurality of light receiving elements to correspond to a first pixel corresponding to the first group, based on a third capture mode (e.g., a low-illumination capture mode). For example, the image sensor 383 may output a short exposure image signal and a long exposure image signal by controlling an exposure time of the image sensor 383, such that a pre-set exposure difference exists based on a fourth capture mode (e.g., an HDR capture mode).

According to an embodiment, the at least one processor 320 may perform a computation on the image signal (e.g., the raw image data) output from the image sensor 383 to obtain image data. For example, the processor 320 may perform at least one computation (e.g., demosaicing or demosaicing (or Bayer interpolation), a computation for adjusting white balance, contrast, saturation values, gamma correction, brightness correction, color correction, sharpening, noise removal, tone mapping, edge enhancement) on the image signal.

For example, the processor 320 may perform remosaicking (or remosaicing) on a first image (e.g., raw image data configured with a non-Bayer pattern) output from the image sensor 383 to create a second image signal (e.g., raw image data configured with a Bayer pattern). For example, the processor 320 may input to an image signal processor (e.g., the image signal processor 260 of FIG. 2) the image signal output from the image sensor 383 to perform at least one computation (e.g., demosaicing, a computation for adjusting white balance, contrast, saturation values, gamma correction, brightness correction, color correction, sharpening, noise removal, tone mapping, edge enhancement). The processor 320 may store the created image data in the memory 330.

For example, the processor 320 may use the image signal to identify an object included in the image. For example, the processor 320 may perform an object recognition computation on the image signal to identify the object included in the image. For example, the processor 320 may identify a primary object and a secondary object among the objects included in the image. For example, the processor 320 may perform face recognition to identify a face included in the image.

According to an embodiment, the at least one processor 320 may initiate an operation of the camera module 380. For example, the processor 320 may provide a Hardware Abstraction Layer (HAL) with a control signal including an Identification (ID) of a camera and an instruction for initiating an operation of the camera to initiate the operation of the camera module 380.

According to an embodiment, the at least one processor 320 may obtain one or more frames. For example, the processor 320 may control the camera module 380 through a request for obtaining a frame to obtain the one or more frames. For example, the processor 320 may obtain a frame for preview, configured with the Bayer pattern. For example, the processor 320 may obtain a frame for capture, configured with the non-Bayer pattern.

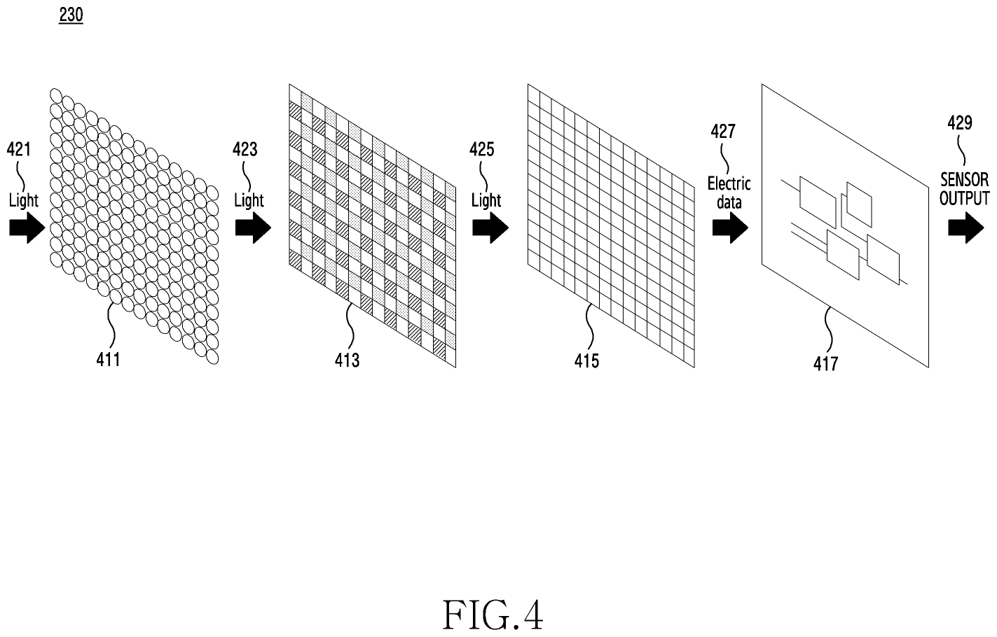

According to an embodiment, the at least one processor 320 may convert a first image signal configured with a first color pattern (e.g., the non-Bayer pattern) into a second image signal configured with a second color pattern (e.g., the Bayer pattern). For example, the processor 320 may perform remosaicking on the first image signal to convert the first image signal into the second image signal. For example, the processor 320 may perform binning on the first image signal to convert the first image signal into the second image signal. For example, the processor 320 may control a computation unit (e.g., a computation unit 417 of FIG. 4) of the image sensor 383 to convert the first image signal into the second image signal.

According to an embodiment, the at least one processor 320 may identify a received user input. For example, the processor 320 may identify a user input for changing a capture mode (e.g., a high-resolution mode, a crop mode, a low-illumination mode, a multi-frame composition mode, a still-picture capture mode, a moving-picture capture mode). For example, the processor 320 may identify a user input for obtaining the still-picture and/or the moving-picture. For example, the processor 320 may identify a user input for obtaining an image in which multi-frames are composited.

According to an embodiment, the at least one processor 320 may obtain preview image data. For example, the processor 320 may create the preview image data by applying an image signal configured with a Bayer pattern, output from the image sensor 383 including a color filter of the Bayer pattern, to the image signal processor 260. For example, the processor 320 may control a computation unit (e.g., the computation unit 417 of FIG. 4) of the image sensor 383 to output the image signal configured the Bayer pattern, by binning an output value of a light receiving element of the image sensor 383 including a color filter of a non-Bayer pattern (e.g., tetra, nona, hexa-deca). For example, the tetra pattern may be a non-Bayer pattern in which a sensor pixel of a 2×2 array corresponds to a color filter of the same color. For example, the nona pattern may be a non-Bayer pattern in which a sensor pixel of a 3×3 array corresponds to a color filter of the same color. For example, the hexa-deca pattern may be a non-Bayer pattern in which a sensor pixel of a 4×4 array corresponds to a color filter of the same color.

According to an embodiment, the at least one processor 320 may obtain a capture image. For example, the processor 320 may perform at least one computation (e.g., demosaicing, a computation for adjusting white balance, contrast, saturation values, gamma correction, brightness correction, color correction, sharpening, noise removal, tone mapping, edge enhancement) on a first image signal configured with a non-Bayer pattern, output from the image sensor 383, to create the capture image. For example, the processor 320 may perform a computation on an image signal of a frame configured with the non-Bayer pattern, based on a high-resolution mode, to create the capture image. For example, the processor 320 may perform the computation on the image signal of the frame configured with the non-Bayer pattern, based on a crop mode, to create the capture image.

According to an embodiment, the at least one processor 320 may display obtained image data by using the display 360. For example, the processor 320 may display preview image data and/or capture image data in at least some regions of a camera application.

According to an embodiment, the display 360 may control the at least one processor 320 to display one or more pieces of information. For example, the display 360 may display a User Interface (UI) of the electronic device. For example, the display 360 may display an execution screen of an application executed in the electronic device. For example, the display 360 may display preview image data and capture image data.

FIG. 4 is a conceptual view illustrating a structure of an image sensor according to an embodiment of the disclosure.

The image sensor of FIG. 4 may correspond to the image sensor 230 and 383 described above with reference to FIGS. 2 and 3.

Referring to FIG. 4, the image sensor according to an embodiment may include a Micro Lens Array (MLA) 411, a Color Filter Array (CFA) 413, a light receiving unit 415, and a computation unit 417,

In an embodiment, the micro lens array 411 may be disposed so that a light bundle 421 passing through a lens assembly (e.g., the lens assembly 210 of FIG. 2) is collected in a light receiving element of the light receiving unit 415. In a light bundle 423 passing through the micro lens array 411, at least part of a wavelength other than a band corresponding to a specific color may be blocked while passing through the color filter array 413.

According to an embodiment, the color filter array 413 may be disposed at a location corresponding to a sensor pixel of the image sensor 230. For example, the sensor pixel is a unit of configuring the image sensor 230, and may correspond to a light receiving element. Light bundles 425 passing through the color filter array 413 may be detected by a light receiving element (e.g., a photo diode) of the light receiving unit 415.

In an embodiment, the light receiving elements of the light receiving unit 415 may include photo diodes disposed to correspond to one micro lens as an array having M rows and N columns. Herein, each of M and N may be a natural number greater than or equal to 1. The light receiving unit 415 may include a light receiving element (e.g., including a light receiving circuit) which creates an electric charge upon receiving light and converts it into an electrical signal and a circuit which selectively reads out an electric charge of the light receiving element. A circuit for digitizing a signal read out from the light receiving unit 415 or for reducing noise may be further disposed between the light receiving unit 415 and the computation unit 417.

In an embodiment, the micro lens array 411 may be disposed to correspond to at least one light receiving element. For example, when viewed from a direction in which the light bundle 421 is incident, a region in which a single micro lens included in the micro lens array 411 is disposed may at least partially overlap an area in which a plurality of light receiving elements are disposed. The micro lenses included in the micro lens array 411 may be disposed to a channel of which color is different from that of an adjacent micro lens, but a plurality of micro lenses corresponding to a channel of the same color may be disposed to be adjacent to each other. The disposition between the micro lens array 411, the color filter array 413, and the light receiving unit 415 may differ depending on a type of an image sensor.

In an embodiment, although a color pattern of the color filter array 413 is illustrated based on the Bayer pattern, the color pattern of the color filter array 413 is not limited to that of FIG. 4. Regions in the color filter array 413 corresponding to a plurality of adjacent micro lenses may be configured to include the same-color channel.

In an embodiment, the computation unit 417 may perform a computation of processing electric data (or signal) 427 output from the light receiving unit 415. The computation unit 417 may output data obtained based on a result of the computation. An output of the computation unit 417 may be a sensor output 429 of the image sensor 230.

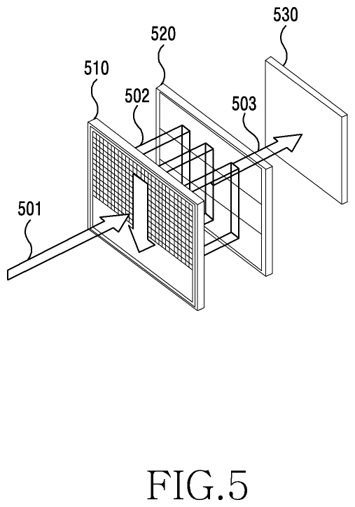

FIG. 5 is a drawing for explaining a structure of an image sensor for obtaining an image through a rolling shutter method, according to an embodiment of the disclosure.

The image sensor of FIG. 5 may correspond to the image sensors 230 and 383 described above with reference to FIGS. 2, 3, and 4.

Referring to FIG. 5, the image sensor according to an embodiment may include an image pixel array 510 and a readout circuit 520. For example, the image pixel array 510 may include the Micro Lens Array (MLA) 411, the Color Filter Array (CFA) 413, and the light receiving unit 415, which are described above with reference to FIG. 4.

According to an embodiment, an image processing engine 530 may be disposed outside the image sensor. For example, the image processing engine 530 may correspond to the processor 320 described above with reference to FIG. 3. For example, at least some of computations performed in the image processing engine 530 may correspond to at least some of computations performed in the processor 320 described above with reference to FIG. 3.

According to an embodiment, the image processing engine 530 may be included in the image sensor. For example, the image processing engine 530 may correspond to the computation unit 417 described above with reference to FIG. 4. For example, at least some of computations performed by the image processing engine 530 may correspond to at least some of computations performed in the computation unit 417 described above with reference to FIG. 4.

According to an embodiment, the image pixel array 510 may include sensor pixels disposed as an array having M rows and N columns (each of M and N may be a natural number greater than or equal to 1). For example, the image pixel array 510 may include M pixel lines. Each of the pixel lines may include sensor pixels included in M rows. Each of the sensor pixels may include a micro lens, a color filter, and a light receiving element.

According to an embodiment, the sensor pixels may be exposed. For example, the sensor pixels may be exposed to a light bundle 501 for a set time duration, in response to a control signal of a processor (e.g., the processor 320 of FIG. 3). For example, the sensor pixels may convert light received for an exposure time into an electric signal. For example, pixel values of the sensor pixels may be determined based on photons received for the exposure time.

According to an embodiment, the processor (e.g., the processor 320 of FIG. 3) may control exposure for each pixel line. For example, the processor (e.g., the processor 320 of FIG. 3) may control an exposure start timing and exposure time for each pixel line. For example, the processor (e.g., the processor 320 of FIG. 3) may control pixel lines so that pixel lines disposed from a first location (e.g., a top or bottom of the image pixel array 510) to a second location (e.g., the bottom or top of the image pixel array 510) of the image pixel array 510 are sequentially exposed.

According to an embodiment, pixel values 502 of the sensor pixels may be read out. For example, the pixel values 502 of the sensor pixels may be read out and provided to the readout circuit 520. For example, the readout circuit 520 may temporarily store the pixel value 502. For example, the pixel values 502 read out from the sensor pixels may be input to the image processing engine 530 via the readout circuit 520.

According to an embodiment, the pixel values 502 of the sensor pixels may be read out for respective pixel lines. For example, the processor (e.g., the processor 320 of FIG. 3) may control the pixel lines such that the pixel values 502 are read out for the respective pixel lines. For example, the processor (e.g., the processor 320 of FIG. 3) may control the pixel lines such that the pixel values 502 of the pixel lines disposed from a first location (e.g., a top or bottom of the image pixel array 510) to a second location (e.g., the bottom or top of the image pixel array 510) are sequentially read out. For example, pixel values 503 sequentially read out from the pixel lines may be input to the image processing engine 530 sequentially via the readout circuit 520.

According to an embodiment, the image processing engine 530 may perform a computation of processing the pixel values 503. For example, the image processing engine 530 may perform a focus control computation (e.g., an Auto Focus (AF) computation). For example, the image processing engine 530 may perform an exposure control computation (e.g., an Auto Exposure (AE) computation). For example, the image processing engine 530 may perform a color control computation (e.g., an Auto White Balance (AWB) computation). For example, the image processing engine 530 may perform a computation of creating an image.

According to an embodiment, the image processing engine 530 may perform the auto focus computation, based on input pixel values. For example, the image processing engine 530 may perform a computation of obtaining information on a distance between a region of object and a camera module (e.g., the camera module 180 of FIG. 2, the camera module 380 of FIG. 3), based on the input pixel values. For example, the image processing engine 530 may perform the computation of obtaining information on a distance between the object of interest and the camera module (e.g., the camera module 180 of FIG. 2, the camera module 380 of FIG. 3), based on a phase difference identified from pixel values. For example, the image processing engine 530 may create a control signal which controls a lens unit (e.g., the lens assembly 210 of FIG. 2, the lens unit 381 of FIG. 3) of the camera module (e.g., the camera module 180 of FIG. 2, the camera module 380 of FIG. 3) to decrease a phase difference identified from pixel values corresponding to a region of interest.

According to an embodiment, the image processing engine 530 may perform an exposure control computation (e.g., an Auto Exposure (AE) computation), based on input pixel values. For example, the image processing engine 530 may perform a computation of identifying a difference between a set first exposure value and a second exposure value identified from the pixel values. For example, the image processing engine 530 may create a control signal which changes at least one value among an aperture, exposure time, and sensitivity of the camera module (e.g., the camera module 180 of FIG. 2, the camera module 380 of FIG. 3), based on the difference between the first exposure value and the second exposure value.

According to an embodiment, the image processing engine 530 may perform a color control computation (e.g., an Auto White Balance (AWB) computation), based on input pixel values. For example, the image processing engine 530 may identify a proper color temperature, based on color information identified from the pixel values. For example, the image processing engine 530 may perform a computation of adjusting a value of a channel of defined color (e.g., red, green, blue), with reference to an identified proper color temperature. For example, the image processing engine 530 may perform a computation such as a gray will algorithm, a white patch search algorithm, a color histogram analysis algorithm, or the like.

According to an embodiment, the image processing engine 530 may create an image, based on input pixel values. For example, the image processing engine 530 may perform at least one computation (e.g., demosaicing, a computation for adjusting white balance, contrast, saturation values, gamma correction, brightness correction, color correction, sharpening, noise removal, tone mapping, edge enhancement) on input raw image data to create the image.

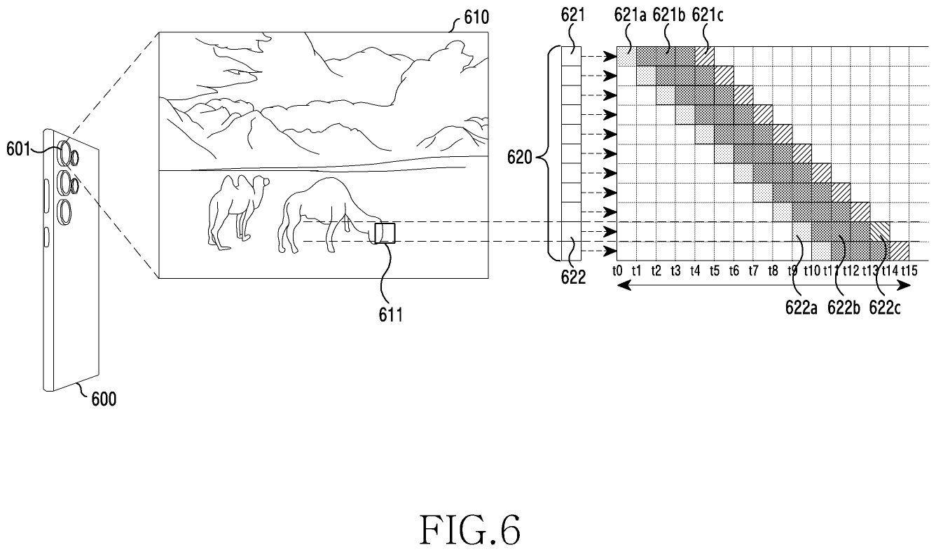

FIG. 6 is a drawing for explaining an operation of obtaining an image by an image sensor which obtains the image through a rolling shutter method, according to an embodiment of the disclosure.

An electronic device 600 of FIG. 6 may correspond to the electronic device 200 of FIG. 2 and the electronic device 101 of FIG. 3. The operation of the electronic device 600 described with reference to FIG. 6 may be performed under the control of a processor (e.g., the processor 320 of FIG. 3).

According to an embodiment, the electronic device 600 may obtain an image 610 by using a camera module 601. For example, the electronic device 600 may obtain the image 610 including at least one object.

According to an embodiment, the electronic device 600 may set a region of interest 611.

For example, the electronic device 600 may set the region of interest 611, based on a user input. For example, the electronic device 600 may receive the user input for setting the region of interest 611. For example, the electronic device 600 may receive a user input for setting a first region of a preview image to the region of interest 611. For example, the electronic device 600 may set the first region to the region of interest 611, in response to receiving of the user input.

For example, the electronic device 600 may analyze the preview image to set the region of interest 611. For example, the electronic device 600 may identify at least one object from the preview image. For example, the electronic device 600 may identify a primary object and a secondary object from the preview image. For example, the electronic device 600 may set the region of interest 611, based on identifying of the primary object. For example, the electronic device 600 may set the first region corresponding to the primary object to the region of interest 611. For example, the electronic device 600 may set the first region corresponding to part of the primary object to the region of interest 611.

According to an embodiment, the electronic device 600 may obtain pixel values for the region of interest 611. For example, the electronic device 600 may identify sensor pixels of an image sensor corresponding to the first region which is set to the region of interest 611. For example, the electronic device 600 may identify second pixel line 622 including the sensor pixels corresponding to the first region. For example, the electronic device 600 may read out the pixel values of the sensor pixels corresponding to the first region from the second pixel line 622 to obtain the pixel values for the region of interest 611.

According to an embodiment, the electronic device 600 may obtain the image 610. For example, the electronic device 600 may convert light received by the image sensor into an electrical signal to obtain the image 610.

According to an embodiment, the camera module 601 may include the image sensor for obtaining the image through the rolling shutter method. For example, the image sensor may include a plurality of pixel lines 620. For example, the image sensor may sequentially expose the plurality of pixel lines 620 and read out pixel values. For example, the image sensor may sequentially expose the pixel lines 620 disposed from a first location (e.g., a top or bottom of the image sensor) to a second location (e.g., the bottom or top of the image sensor) and read out the pixel values.

According to an embodiment, the electronic device 600 may obtain image data from first sensor pixels included in a first pixel line 621 of the image sensor. For example, the electronic device 600 may initialize the first sensor pixels. For example, the electronic device 600 may expose the first sensor pixels. For example, the electronic device 600 may read out pixel values from the first sensor pixels.

For example, in the first pixel line 621, sensor pixels may be subjected to initialization 621a for a first time duration (e.g., t0 to t1). The initialization 621a of the sensor pixels may include an operation of initializing an electric charge accumulated in the sensor pixels. For example, an operation in which the electronic device 600 initializes the sensor pixels may include an operation of releasing the electric charge accumulated in the sensor pixels and initializing voltage.

For example, in the first pixel line 621, the sensor pixels may be subjected to exposure 621b for a second time duration (e.g., t1 to t4). For example, in the first pixel line 621, the exposure 621b of the sensor pixels may start at t1. For example, in the first pixel line 621, the exposure 621b of the sensor pixels may end at 14.

For example, in the first pixel line 621, the pixel values may be subjected to readout 621c for a third time duration (e.g., 14 to 15). For example, in the first pixel line 621, a voltage value corresponding to an electric charge accumulated in the sensor pixels may be read out for the third time duration.

According to an embodiment, the electronic device 600 may obtain image data from second sensor pixels included in the second pixel line 622 of the image sensor. The second pixel line 622 may include sensor pixels corresponding to the region of interest 611. For example, the electronic device 600 may initialize the second sensor pixels. For example, the electronic device 600 may expose the second sensor pixels. For example, the electronic device 600 may read out pixel values from the second sensor pixels.

For example, in the second pixel line 622, the sensor pixels may be subjected to initialization 622a for a fourth time duration (e.g., t9 to t10). The initialization of the sensor pixels may include an operation of initializing an electric charge accumulated in the sensor pixels. For example, an operation of initializing the sensor pixels may include an operation of releasing the electric charge accumulated in the sensor pixels and initializing voltage.

For example, in the second pixel line 622, the sensor pixels may be subjected to exposure 622b for a fifth time duration (e.g., t10 to t13). For example, in the second pixel line 622, the exposure 622b of the sensor pixels may start at t10. For example, in the second pixel line 622, the exposure 622b of the sensor pixels may end at t13.

For example, in the second pixel line 622, the pixel values may be subjected to readout 622c for a sixth time duration (e.g., t13 to t14). For example, in the second pixel line 622, a voltage value corresponding to an electric charge accumulated in the sensor pixels may be read out for the sixth time duration.

Referring to FIG. 6, the image sensor of the roller shutter method may read out the pixel value later in the second pixel line 622 than in the first pixel line 621. Therefore, at least one computation among a focus control computation (e.g., an Auto Focus (AF) computation), an exposure control computation (e.g., an Auto Exposure (AF) computation), and a color control computation (e.g., an Auto White Balance (AWB) computation) which are performed by using pixel values of sensor pixels corresponding to the region of interest 611 may be delayed.

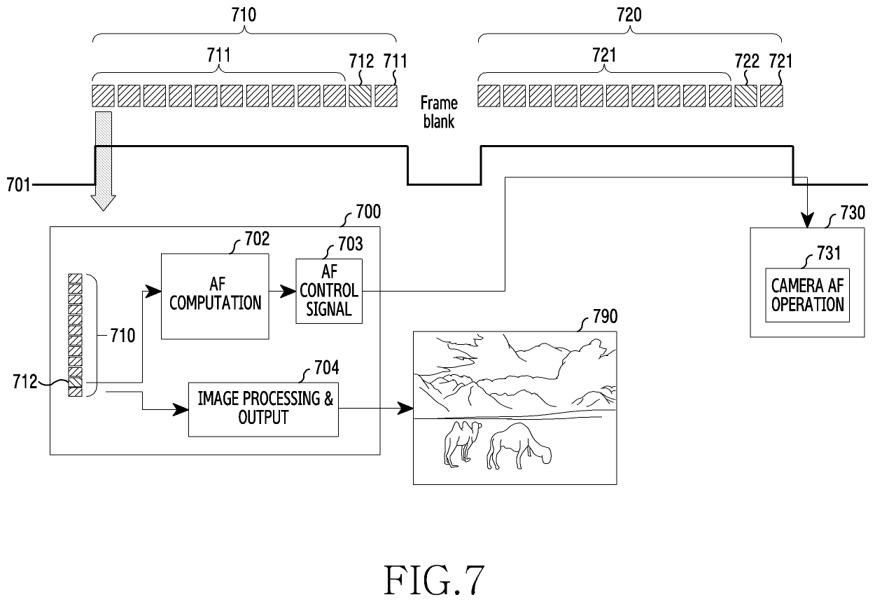

FIG. 7 is a drawing for explaining an operation in which an electronic device controls a camera module by using an image obtained through a rolling shutter method, according to an embodiment of the disclosure.

FIG. 7 illustrates a time duration considered in an AF operation by using pixel values obtained by the electronic device 600 of FIG. 6 through the pixel line 620 of the camera module 601. An electronic device 700 of FIG. 7 may correspond to the electronic device 600 of FIG. 6. An operation of the electronic device 700 described with reference to FIG. 7 may be performed under the control of a processor (e.g., the processor 320 of FIG. 3).

Although an embodiment in which the electronic device 700 uses pixel values 710 to obtain a first image is described hereinafter with reference to FIG. 7, it may also be applied to an embodiment in which the electronic device 700 uses pixel values 720 to obtain a second image. Redundant description will be omitted.

According to an embodiment, the electronic device 700 may sequentially read out the pixel values 710 and 720 from pixel lines (e.g., the pixel lines 620 of FIG. 6) of an image sensor. For example, the image sensor may read out the pixel lines 710 and 720 from the pixel lines (e.g., the pixel lines 620 of FIG. 6), based on a control signal 701. For example, the electronic device 700 may obtain pixel values constituting the first image in response to the control signal 701. For example, the electronic device 700 may obtain pixel values constituting the second image in response to the control signal 701.

For example, the pixel lines (e.g., the pixel lines 620 of FIG. 6) may be sequentially exposed, and the pixel values 710 and 720 may be read out. For example, first pixel values 712 and 722 may be read out from a first pixel line (e.g., the second pixel line 622 of FIG. 6), including sensor pixels corresponding to a region of interest (e.g., the region of interest 611 of FIG. 6). For example, second pixel values 711 and 721 may be read out from a pixel line (e.g., the first pixel line 621 of FIG. 6) not including sensor pixels corresponding to the region of interest (e.g., the region of interest 611 of FIG. 6). For example, the first pixel values 712 and 722 may be read out later than some of the second pixel values 711 and 721, according to a location of the region of interest (e.g., the region of interest 611 of FIG. 6).

According to an embodiment, the electronic device 700 may use the read-out pixel values to obtain an image. For example, the electronic device 700 may reconfigure the pixel value 710 to obtain a first image 790.

According to an embodiment, the electronic device 700 may perform image processing on the pixel value 710 to create the first image 790. The electronic device 700 may use a display (e.g., the display 360 of FIG. 3) to output the first image 790 (see 704).

For example, the electronic device 700 may perform at least one computation (e.g., demosaicing, a computation for adjusting white balance, contrast, saturation values, gamma correction, brightness correction, color correction, sharpening, noise removal, tone mapping, edge enhancement) for image processing. For example, the electronic device 700 may use the display (e.g., the display 360 of FIG. 3) to display the first image 790 created through image processing.

According to an embodiment, the electronic device 700 may perform a color control computation (e.g., an Auto White Balance (AWB) computation), based on information on color of a region of interest obtained from pixel values corresponding to the region of interest. The electronic device 700 may obtain a first image of which color is adjusted through the color control computation. For example, the processor (e.g., the processor 320 of FIG. 3) may perform a computation of defining a color temperature and/or tint, based on color information identified from pixel values. For example, the processor (e.g., the processor 320 of FIG. 3) may perform a computation of adjusting a value of a channel of defined color (e.g., red, green, blue), with reference to a defined proper color temperature and/or tint. For example, the processor (e.g., the processor 320 of FIG. 3) may perform a computation such as a gray will algorithm, a white patch search algorithm, a color histogram analysis algorithm, or the like.

According to an embodiment, the electronic device 700 may perform a computation of controlling a camera module by using the readout pixel values 710. For example, the electronic device 700 may perform a focus control computation (e.g., an Auto Focus (AF) computation) and an exposure control computation (e.g., an Auto Exposure (AE) computation).

According to an embodiment, the electronic device may use the first pixel value 712 obtained from sensor pixels corresponding to a region of interest (e.g., the region of interest 611 of FIG. 6) to perform a focus control computation 702. For example, the electronic device 700 may perform the focus control computation 702, through the processor (e.g., the processor 320 of FIG. 3). For example, the processor (e.g., the processor 320 of FIG. 3) may perform a computation of obtaining information on a distance between a region of object and a camera module 730 (e.g., the camera module 180 of FIG. 2, the camera module 380 of FIG. 3), based on input pixel values. For example, the processor (e.g., the processor 320 of FIG. 3) may perform a computation of obtaining information on a distance between the camera module 730 and an object of interest, based on a phase difference identified from pixel values. For example, the processor (e.g., the processor 320 of FIG. 3) may create a AF control signal 703 which controls a lens unit (e.g., the lens assembly 210 of FIG. 2, the lens unit 381 of FIG. 3) of a camera module (e.g., the camera module 180 of FIG. 2, the camera module 380 of FIG. 3) to decrease a phase difference identified from pixel values corresponding to a region of interest.

According to an embodiment, the electronic device 700 may control the camera module 730, based on the control signal 701. For example, the electronic device 700 may provide focus control (e.g., Auto Focus (AF) control) and exposure control (e.g., Auto Exposure (AE) control). For example, the electronic device 700 may control a camera AF operation 731 which moves at least one lens of a lens assembly (e.g., the lens assembly 210 of FIG. 2).

According to an embodiment, the processor (e.g., the processor 320 of FIG. 3) may use a pixel value obtained from sensor pixels corresponding to a region of interest (e.g., the region of interest 611 of FIG. 6) to perform a focus control computation of a camera module (e.g., the camera module 601 of FIG. 6). For example, in the camera module (e.g., the camera module 601 of FIG. 6), at least one lens of the lens assembly (e.g., the lens assembly 210 of FIG. 2) may move so that the region of interest (e.g., the region of interest 611 of FIG. 6) is kept in focus. For example, the processor (e.g., the processor 320 of FIG. 3) may perform a computation of obtaining information on a distance between an object of interest and the camera module (e.g., the camera module 180 of FIG. 2, the camera module 380 of FIG. 3).

For example, the processor (e.g., the processor 320 of FIG. 3) may perform a computation of obtaining information on a distance between an object of interest and the camera module 730 (e.g., the camera module 180 of FIG. 2, the camera module 380 of FIG. 3), based on a phase difference identified from pixel values. For example, the processor (e.g., the processor 320 of FIG. 3) may create the AF control signal 703 which controls the lens unit (e.g., the lens assembly 210 of FIG. 2, the lens unit 381 of FIG. 3) of the camera module 730 (e.g., the camera module 180 of FIG. 2, the camera module 380 of FIG. 3) to decrease a phase difference identified from pixel values corresponding to a region of interest.

According to an embodiment, the processor (e.g., the processor 320 of FIG. 3) may use the first pixel value 712 obtained from sensor pixels corresponding to a region of interest (e.g., the region of interest 611 of FIG. 6) to perform an exposure control computation (e.g., an Auto Exposure (AE) computation). For example, the processor (e.g., the processor 320 of FIG. 3) may perform a computation of identifying a first exposure value (e.g., a brightness value), based on input pixel values. For example, the processor (e.g., the processor 320 of FIG. 3) may perform a computation of comparing the identified first exposure value and a second exposure value. For example, the processor (e.g., the processor 320 of FIG. 3) may create a control signal which changes at least one value among an aperture, exposure time, and sensitivity of the camera module 730 (e.g., the camera module 180 of FIG. 2, the camera module 380 of FIG. 3), based on the difference between the first exposure value and the second exposure value.

Referring to FIG. 7, the electronic device 700 may use an image sensor of the rolling shutter method to obtain the pixel values 710. Since the electronic device 700 reads out the first pixel value 712 later than at least some of the second pixel values 711, there may not be enough time to perform a computation for controlling a camera module (e.g., the camera module 601 of FIG. 6) by using the first pixel values 712 and 722. When the camera module (e.g., the camera module 601 of FIG. 6) obtains a second image, a control signal obtained by using the first pixel values 712 and 722 may not be used. For example, the AF control signal 703 obtained based on the first pixel value 712 may not be used when the camera module (e.g., the camera module 601 of FIG. 6) obtains the second image.

In this case, the camera module (e.g., the camera module 601 of FIG. 6) may obtain the second image which is out of focus in a region of interest (e.g., the region of interest 611 of FIG. 6). For example, an exposure control signal obtained based on the first pixel value 712 may not be used when the camera module (e.g., the camera module 601 of FIG. 6) obtains the second image. In this case, the camera module (e.g., the camera module 601 of FIG. 6) may obtain the second image having a first exposure value different from a set second exposure value.

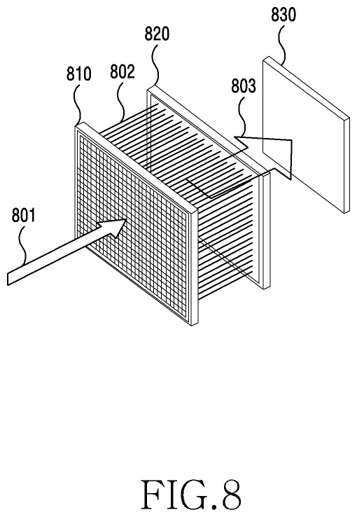

FIG. 8 is a drawing for explaining a structure of an image sensor for obtaining an image through a global shutter method, according to an embodiment of the disclosure.

The image sensor of FIG. 8 may correspond to the image sensors 230 and 383 described above with reference to FIGS. 2, 3, and 4.

Referring to FIG. 8, the image sensor according to an embodiment may include a pixel array 810 and a readout circuit 820. For example, the pixel array 810 may include the Micro Lens Array (MLA) 411, the Color Filter Array (CFA) 413, and the light receiving unit 415, which are described above with reference to FIG. 4.

According to an embodiment, an image processing engine 830 may be disposed outside the image sensor. For example, the image processing engine 830 may correspond to the processor 320 described above with reference to FIG. 3. For example, at least some of computations performed in the image processing engine 830 may correspond to at least some of computations performed in the processor 320 described above with reference to FIG. 3.

According to an embodiment, the image processing engine 830 may be included in the image sensor. For example, the image processing engine 830 may correspond to the computation unit 417 described above with reference to FIG. 4. For example, at least some of computations performed by the image processing engine 830 may correspond to at least some of computations performed in the computation unit 417 described above with reference to FIG. 4.

According to an embodiment, all sensor pixels included in the pixel array 810 may be simultaneously exposed. Such a method may be referred to as a global shutter method. The image sensor which creates the image through the global shutter method may sequentially read out the pixel lines disposed from a first location (e.g., a top or bottom of the image sensor) to a second location (e.g., the bottom or top of the image sensor).

According to an embodiment, the image pixel array 810 may include sensor pixels disposed as an array having M rows and N columns (each of M and N may be a natural number greater than or equal to 1). For example, the image pixel array 810 may include M pixel lines. Each of the pixel lines may include sensor pixels included in M rows. Each of the sensor pixels may include a micro lens, a color filter, and a light receiving element.

According to an embodiment, the sensor pixels may be exposed. For example, the sensor pixels may be exposed to a light bundle 801 for a set time duration, in response to a control signal of a processor (e.g., the processor 320 of FIG. 3). For example, the sensor pixels may convert light received for an exposure time into an electric signal. For example, pixel values of the sensor pixels may be determined based on photons received for the exposure time.

According to an embodiment, pixel values of the sensor pixels may be read out. For example, the pixel values of the sensor pixels may be read out and provided to the readout circuit 820. For example, the readout circuit 820 may temporarily store the pixel value. For example, the pixel values read out from the sensor pixels may be input to the image processing engine 830 via the readout circuit 820.

According to an embodiment, pixel values 802 of the respective sensor pixels may be read out. For example, the processor (e.g., the processor 320 of FIG. 3) may control sensor pixels and/or pixel lines such that the pixel values 802 are read out from the respective sensor pixels.

According to an embodiment, the pixel values 802 of the sensor pixels may be read out for respective pixel lines. For example, the processor (e.g., the processor 320 of FIG. 3) may control the pixel lines such that the pixel values 802 are read out for the respective pixel lines. For example, the processor (e.g., the processor 320 of FIG. 3) may control the pixel lines such that the pixel values 802 of the pixel lines disposed from a first location (e.g., a top or bottom of the image pixel array 810) to a second location (e.g., the bottom or top of the image pixel array 810) are sequentially read out. For example, pixel values 803 sequentially read out from the pixel lines may be input to the image processing engine 830 sequentially via the readout circuit 820.

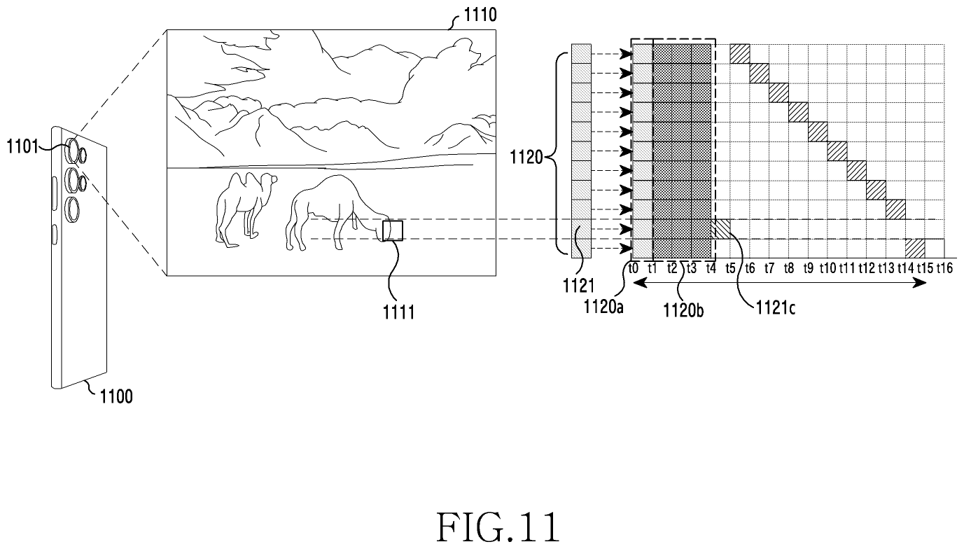

According to an embodiment, the processor (e.g., the processor 320 of FIG. 3) may control an order of reading out the pixel values 802 of the pixel lines. For example, the processor (e.g., the processor 320 of FIG. 3) may read out a pixel value of a pixel line including a region of interest in preference to pixel values of other pixel lines. For example, the processor (e.g., the processor 320 of FIG. 3) may read out first pixel values of a first pixel line including a region of interest (e.g., a first pixel line 1121 of FIG. 11) in preference to second pixel values of a second pixel line not including the region of interest.

According to an embodiment, the image processing engine 830 may perform a computation of processing the pixel values. For example, the image processing engine 830 may perform a focus control computation (e.g., an Auto Focus (AF) computation). For example, the image processing engine 830 may perform an exposure control computation (e.g., an Auto Exposure (AE) computation). For example, the image processing engine 830 may perform a color control computation (e.g., an Auto White Balance (AWB) computation). For example, the image processing engine 830 may perform a computation of creating an image.

According to an embodiment, the image processing engine 830 may perform the focus control computation, based on first pixel values of a first pixel line (e.g., the first pixel line 1121 of FIG. 11). For example, the image processing engine 830 may perform a computation of obtaining information on a distance between a camera module (e.g., the camera module 180 of FIG. 2, the camera module 380 of FIG. 3) and an object of interest, based on the first pixel values. For example, the image processing engine 830 may perform a computation of obtaining information on the distance between the camera module (e.g., the camera module 180 of FIG. 2, the camera module 380 of FIG. 3) and the object of interest, based on a phase difference identified from the first pixel values. For example, the image processing engine 830 may create a control signal which controls a lens unit (e.g., the lens assembly 210 of FIG. 2, the lens unit 381 of FIG. 3) of the camera module (e.g., the camera module 180 of FIG. 2, the camera module 380 of FIG. 3) to decrease the phase difference identified from the first pixel values.

According to an embodiment, the image processing engine 830 may perform the exposure control computation (e.g., the AE operation), based on the first pixel values of the first pixel line (e.g., the first pixel line 1121 of FIG. 11). For example, the image processing engine 830 may perform a computation of identifying a difference between a set first exposure value and a second exposure value identified from the first pixel values. For example, the image processing engine 830 may create a control signal which changes at least one value among an aperture, exposure time, and sensitivity of a camera module (e.g., the camera module 180 of FIG. 2, the camera module 380 of FIG. 3), based on the difference between the first exposure value and the second exposure value.

According to an embodiment, the image processing engine 830 may perform a color control computation (e.g., an Auto White Balance (AWB) computation), based on the first pixel values of the first pixel line (e.g., the first pixel line 1121 of FIG. 11). For example, the image processing engine 830 may identify a proper color temperature, based on color information identified from the pixel values. For example, the image processing engine 830 may perform a computation of adjusting a value of a channel of defined color (e.g., red, green, blue), with reference to an identified proper color temperature. For example, the image processing engine 830 may perform a computation such as a gray will algorithm, a white patch search algorithm, a color histogram analysis algorithm, or the like.

According to an embodiment, the image processing engine 830 may create an image, based on the first pixel values and the second pixel values. For example, the image processing engine 830 may perform at least one computation (e.g., demosaicing, a computation for adjusting white balance, contrast, saturation values, gamma correction, brightness correction, color correction, sharpening, noise removal, tone mapping, edge enhancement) on input raw image data to create the image.

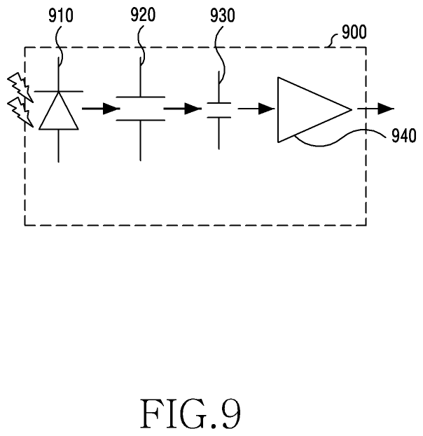

FIG. 9 is a drawing for explaining a sensor pixel of an image sensor which obtains an image through a global shutter method, according to an embodiment of the disclosure.

A sensor pixel 900 of FIG. 9 may correspond to a sensor pixel included in the pixel array 810 described above with reference to FIG. 8. A photo diode 910 of FIG. 9 may correspond to a light receiving element of the light receiving unit 415 described above with reference to FIG. 4.

According to an embodiment, the sensor pixel 900 may include the photo diode 910, a charge domain capacitor 920, a Floating Diffusion (FD) 930, and a Source Follower (SF) amplifier 940. However, the disclosure is not limited thereto, and the sensor pixel 900 may include more or fewer components than those illustrated in FIG. 9. For example, some of the components illustrated in FIG. 9 may be included in the readout circuit 820 described above with reference to FIG. 8. For example, the charge domain capacitor 920, the FD 930, and/or the SF amplifier 940 may be included in the readout circuit 820.

According to an embodiment, the photo diode 910 may produce an electric charge, based on photons detected when a sensor pixel is exposed. For example, electrons and holes may be produced in the photo diode 910, based on the detected photons. For example, the electric charge may be accumulated in the photo diode 910 due to the electrons and the holes.

According to an embodiment, the charge domain capacitor 920 may have an electric charge accumulated by the electrons and holes produced in the photo diode 910. For example, the charge domain capacitor 920 may store the accumulated electric charge. For example, the charge domain capacitor 920 may store the electric charge temporarily until the electric charge is read out. The charge domain capacitor 920 temporarily stores the electric charge, and thus all sensor pixels of the image sensor may be simultaneously exposed.

According to an embodiment, the FD 930 may convert the electric charge produced in the photo diode 910 into voltage. For example, the FD 930 may be coupled to the domain capacitor 920 to produce voltage corresponding to the electric charge stored by the domain capacitor 920. For example, the voltage produced in the FD 930 may be converted into an electric signal indicating intensity of light received by the sensor pixel.

According to an embodiment, the SF amplifier 940 may amplify and/or transfer the electric signal produced in the FD 930. For example, the voltage produced in the FD 930 may be input to the SF amplifier 940. For example, the SF amplifier 940 may amplify the input voltage. For example, the SF amplifier 940 may perform a function of a buffer which transfers or temporarily stores the electric signal. For example, the SF amplifier 940 may transfer the electric signal to a computation circuit (e.g., the computation unit 417 of FIG. 4). For example, the SF amplifier 940 may transfer the voltage produced in the FD 930 to the computation circuit. For example, the SF amplifier 940 may transfer to the computation circuit the electric signal obtained by amplifying the voltage input from the FD 930

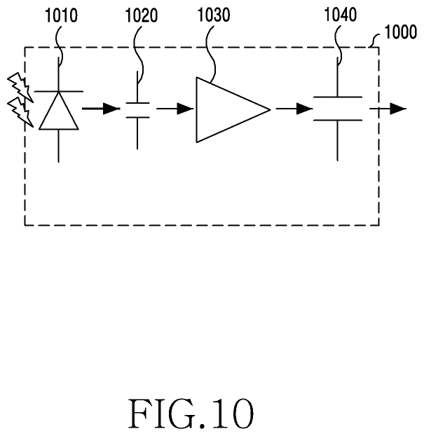

FIG. 10 is a drawing for explaining a sensor pixel of an image sensor which obtains an image through a global shutter method, according to an embodiment of the disclosure.

A sensor pixel 1000 of FIG. 10 may correspond to a sensor pixel included in the pixel array 810 described above with reference to FIG. 8. A photo diode 1010 of FIG. 10 may correspond to a light receiving element of the light receiving unit 415 described above with reference to FIG. 4.

According to an embodiment, the sensor pixel 1000 may include the photo diode 1010, an FD 1020, an SF amplifier 1030, and a voltage domain capacitor 1040. However, the disclosure is not limited thereto, and the sensor pixel 1000 may include more or fewer components than those illustrated in FIG. 10. For example, some of the components illustrated in FIG. 10 may be included in the readout circuit 820 described above with reference to FIG. 8. For example, the FD 1020, the SF amplifier 1030, and/or the voltage domain capacitor 1040 may be included in the readout circuit 820.

According to an embodiment, the photo diode 1010 may produce an electric charge, based on photons detected when the sensor pixel 1000 is exposed. For example, electrons and holes may be produced in the photo diode 1010, based on the detected photons. For example, the electric charge may be accumulated in the photo diode 1010 due to the electrons and the holes.

According to an embodiment, the FD 1020 may convert the electric charge produced in the photo diode 1010 into voltage. For example, the FD 1020 may be coupled to the photo diode 1010 to produce voltage corresponding to the electric charge accumulated in the photo diode 1010. For example, the voltage produced in the FD 1020 may be converted into an electric signal indicating intensity of light received by the sensor pixel.

According to an embodiment, the SF amplifier 1030 may amplify and/or transfer the electric signal produced in the FD 1020. For example, the voltage produced in the SF amplifier 1030 may be input to the SF amplifier 1030. For example, the SF amplifier 1030 may amplify the input voltage. For example, the SF amplifier 1030 may perform a function of a buffer which transfers or temporarily stores the electric signal.

According to an embodiment, the voltage domain capacitor 1040 may store a voltage value. For example, the voltage domain capacitor 1040 may store the electric signal output from the SF amplifier 1030. For example, the voltage domain capacitor 1040 may be coupled to the SF amplifier 1030 to store the voltage value output from the SF amplifier 1030. For example, the voltage domain capacitor 1040 may transfer the electric signal of the stored voltage value to a computation circuit. For example, the voltage domain capacitor 1040 temporarily stores the voltage value, and thus all sensor pixels of the image sensor may be simultaneously exposed.

FIG. 11 is a drawing for explaining an operation of obtaining an image by an image sensor which obtains the image through a global shutter method, according to an embodiment of the disclosure.

An electronic device 1100 of FIG. 11 may correspond to the electronic device 200 of FIG. 2 and the electronic device 101 of FIG. 3. The operation of the electronic device 1100 described with reference to FIG. 11 may be performed under the control of a processor (e.g., the processor 320 of FIG. 3).

According to an embodiment, the electronic device 1100 may use a camera module 1101 to obtain an image 1110. For example, the electronic device 1100 may obtain the image 1110 including at least one object.

According to an embodiment, the electronic device 1100 may set a region of interest 1111.

For example, the electronic device 1100 may set the region of interest 1111, based on a user input. For example, the electronic device 1100 may receive a user input for setting the region of interest 1111. For example, the electronic device 1100 may set a first region of a preview image to the region of interest 1111, in response to receiving the user input.

For example, the electronic device 1100 may analyze the preview image to set the region of interest 1111. For example, the electronic device 1100 may identify at least one object from the preview image. For example, the electronic device 1100 may identify a primary object and a secondary object from the preview image. For example, the electronic device 1100 may set the region of interest 1111, based on identifying of the primary object. For example, the electronic device 1100 may set the first region corresponding to the primary object to the region of interest 1111. For example, the electronic device 1100 may set the first region corresponding to part of the primary object to the region of interest 1111.

According to an embodiment, the electronic device 1100 may obtain pixel values for the region of interest 1111. For example, the electronic device 1100 may identify sensor pixels of an image sensor corresponding to the first region which is set to the region of interest 1111. For example, the electronic device 1100 may identify first pixel lines 1121 including the sensor pixels corresponding to the first region. For example, the electronic device 1100 may read out the pixel values of the sensor pixels corresponding to the first region from the first pixel line 1121 to obtain the pixel values for the region of interest 1111.

According to an embodiment, the electronic device 1100 may obtain the image 1110. For example, the electronic device 1100 may convert light received by the image sensor into an electrical signal to obtain the image 1110.

According to an embodiment, the camera module 1101 may include the image sensor for obtaining the image through the global shutter method. For example, the image sensor may include a plurality of pixel lines 1120. The image sensor may sequentially read out pixel values from the plurality of pixel lines. For example, the image sensor may sequentially read out the pixel lines disposed from a first location (e.g., a top or bottom of the image sensor) to a second location (e.g., the bottom or top of the image sensor).

According to an embodiment, the sensor pixels included in the plurality of pixel lines of the image sensor may be simultaneously subjected to initialization 1120a. For example, the electronic device 1100 may perform the initialization 1120a on all sensor pixels included in the image sensor. For example, the electronic device 1100 may perform the initialization 1120a on the sensor pixels for a first time duration (e.g., t0 to t1). The initialization of the sensor pixels may include an operation of initializing an electric charge accumulated in the sensor pixels. For example, the operation of initializing the sensor pixels may include an operation of releasing the electric charge accumulated in the sensor pixels and initializing voltage.

According to an embodiment, the sensor pixels included in the plurality of pixel lines 1120 of the image sensor may be simultaneously subjected to exposure 1120b. For example, all of the pixel lines 1120 of the image sensor may have sensor pixels subjected to the exposure 1120b for a second time duration (e.g., t1 to t4). For example, the plurality of pixel lines 1120 may have sensor pixels on which the exposure 1120b starts at t1. For example, the plurality of pixel lines 1120 may have the sensor pixels on which the exposure 1120b ends at 14.

According to an embodiment, the electronic device 1100 may control an order of reading out pixel values of pixel lines. For example, the electronic device 1100 may read out a pixel value including a region of interest in preference to pixel values of other pixel lines. For example, a pixel value of the first pixel line 1121 including the region of interest may be read out in preference to a pixel value of a second pixel line not including the region of interest. For example, the pixel values of the first pixel line 1121 may be subjected to readout 1121c at 14 to 15. For example, the pixel values of the second pixel lines may be sequentially read out after 15. For example, the pixel values may be sequentially read out from the second pixel line disposed to a first location (e.g., a top or bottom of an image sensor) to a second location (e.g., the bottom or top of the image sensor).

Referring to FIG. 11, the image sensor of the global shutter method may read out the pixel value faster in the first pixel line 1121 than in the second pixel line. Therefore, at least one computation among a focus control computation (e.g., an AF computation), an exposure control computation (e.g., an AE operation), and a color control computation (e.g., an AWB operation) may be performed without delay by using pixel values of sensor pixels corresponding to a region of interest.

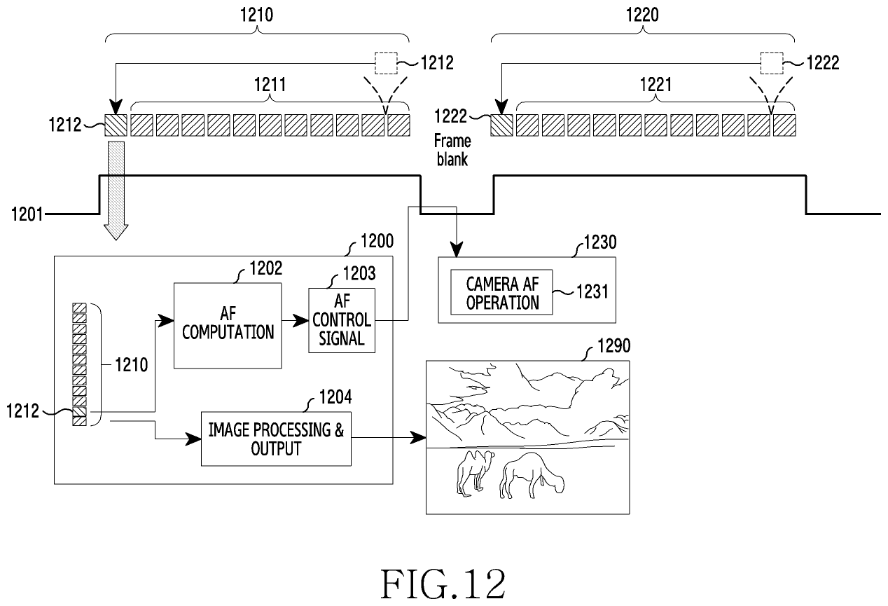

FIG. 12 is a drawing for explaining an operation in which an electronic device controls a camera module by using an image obtained through a global shutter method, according to an embodiment of the disclosure.

FIG. 12 illustrates a time duration considered in an AF operation by using pixel values obtained by the electronic device 1100 of FIG. 11 through the pixel line 1120 of the camera module 1101. An electronic device 1200 of FIG. 12 may correspond to the electronic device 1100 of FIG. 11. An operation of the electronic device 1200 described with reference to FIG. 12 may be performed under the control of a processor (e.g., the processor 320 of FIG. 3).

Although an embodiment in which the electronic device 1200 uses pixel values 1210 to obtain a first image 1290 is described hereinafter with reference to FIG. 12, it may also be applied to an embodiment in which the electronic device 1200 uses pixel values 1220 to obtain a second image. Redundant description will be omitted.

According to an embodiment, the electronic device (e.g., the electronic device 1100 of FIG. 11) may read out the pixel values 1210 and 1220 from pixel lines of an image sensor. For example, the image sensor may read out the pixel values 1210 and 1220, based on a control signal 1201. For example, the image sensor may obtain pixel values constituting the first image 1290 in response to the control signal 1201. For example, the image sensor may obtain pixel values constituting the second image in response to the control signal 1201.

According to an embodiment, the electronic device 1200 may control an order of reading out pixel values of pixel lines. For example, the electronic device 1200 may read out a first pixel values 1212 of a first pixel line (e.g., the first pixel line 1121 of FIG. 11) including a region of interest in preference to second pixel values 1211 of other pixel lines. For example, the first pixel values 1212 of the first pixel line (e.g., the first pixel line 1121 of FIG. 11) including the region of interest may be read out in preference to the second pixel values 1211 of a second pixel line not including the region of interest. For example, the second pixel values 1211 of the second pixel lines may be sequentially read out. For example, the pixel values may be sequentially read out from the second pixel line disposed to a first location (e.g., a top or bottom of an image sensor) to a second location (e.g., the bottom or top of the image sensor).

According to an embodiment, the electronic device 1200 may obtain line data including a tag. The line data may include a pixel value obtained from a pixel line. The tag may include information related to the line data. For example, the tag may include information on a region of interest (e.g., a coordinate of the region of interest). For example, the tag may include information on a location of a pixel line corresponding to the line data including the tag among the plurality of pixel lines. For example, a tag of a first pixel line (e.g., the first pixel line 1121 of FIG. 11) may include information on an order of disposing the first pixel line from a first location (e.g., a top or bottom of an image sensor) to a second location (e.g., the bottom or top of the image sensor) among the plurality of pixel lines (e.g., the pixel lines 1120 of FIG. 11). For example, the tag of the first pixel line (e.g., the first pixel line 1121 of FIG. 11) may include information for identifying that it is a 11^{th} pixel line from the top of the image sensor.

According to an embodiment, the electronic device 1200 may use the read-out pixel values to obtain an image. For example, the electronic device 1200 may reconfigure the pixel value 1210 to obtain the first image 1290.

According to an embodiment, the electronic device 1200 may reconfigure the location of the pixel values, based on the tag, to obtain the first image 1290. For example, the electronic device 1200 may identify a location of the first pixel line (e.g., the first pixel line 1121 of FIG. 11) among the plurality of pixel lines, based on information on the location of the first pixel line (e.g., the first pixel line 1121 of FIG. 11) included in the tag. For example, the electronic device 1200 may sequentially arrange pixel values to correspond to an order of disposing pixel lines in accordance with the location of the first pixel line (e.g., the first pixel line 1121 of FIG. 11). The electronic device 1200 may use the pixel values arranged sequentially to obtain the first image 1290.

According to an embodiment, the electronic device 1200 may perform image processing on the pixel value 1210 to create the first image 1290. The electronic device 1200 may use a display (e.g., the display 360 of FIG. 3) to output the first image 1290 (see 1204).

For example, the electronic device 1200 may perform at least one computation (e.g., demosaicing, a computation for adjusting white balance, contrast, saturation values, gamma correction, brightness correction, color correction, sharpening, noise removal, tone mapping, edge enhancement) for image processing. For example, the electronic device 1200 may use the display (e.g., the display 360 of FIG. 3) to display the first image 1290 created through image processing.

According to an embodiment, the electronic device 1200 may perform a color control computation (e.g., an Auto White Balance (AWB) computation), based on information on color of a region of interest obtained from pixel values corresponding to the region of interest. The electronic device 1200 may obtain a first image of which color is adjusted through the color control computation. For example, the processor (e.g., the processor 320 of FIG. 3) may perform a computation of defining a color temperature and/or tint, based on color information identified from pixel values. For example, the processor (e.g., the processor 320 of FIG. 3) may perform a computation of adjusting a value of a channel of defined color (e.g., red, green, blue), with reference to a defined proper color temperature and/or tint. For example, the processor (e.g., the processor 320 of FIG. 3) may perform a computation such as a gray will algorithm, a white patch search algorithm, a color histogram analysis algorithm, or the like.

According to an embodiment, the electronic device 1200 may control a camera module 1230, based on the control signal 1201. For example, the electronic device 1200 may provide focus control (e.g., Auto Focus (AF) control) and exposure control (e.g., Auto Exposure (AE) control). For example, the electronic device 1200 may control a camera AF operation 1231 which moves at least one lens of a lens assembly (e.g., the lens assembly 210 of FIG. 2).

According to an embodiment, the processor (e.g., the processor 320 of FIG. 3) may use a pixel value obtained from sensor pixels corresponding to a region of interest (e.g., the region of interest 1111 of FIG. 11) to perform a focus control computation 1202 of a camera module (e.g., the camera module 1101 of FIG. 11). For example, in the camera module (e.g., the camera module 1101 of FIG. 11), at least one lens of the lens assembly (e.g., the lens assembly 210 of FIG. 2) may move so that the region of interest (e.g., the region of interest 1111 of FIG. 11) is kept in focus. For example, the processor (e.g., the processor 320 of FIG. 3) may perform a computation of obtaining information on a distance between an object of interest and a camera module (e.g., the camera module 180 of FIG. 3, the camera module 380 of FIG. 3). For example, the processor (e.g., the processor 320 of FIG. 3) may perform a computation of obtaining information on a distance between an object of interest and the camera module (e.g., the camera module 180 of FIG. 2, the camera module 380 of FIG. 3), based on a phase difference identified from pixel values. For example, the processor (e.g., the processor 320 of FIG. 3) may create an AF control signal 1203 which controls the lens unit (e.g., the lens assembly 210 of FIG. 2, the lens unit 381 of FIG. 3) of the camera module (e.g., the camera module 180 of FIG. 2, the camera module 380 of FIG. 3), so that there is no phase difference identified from the pixel values.

According to an embodiment, the processor (e.g., the processor 320 of FIG. 3) may use a pixel value obtained from sensor pixels corresponding to a region of interest (e.g., the region of interest 1111 of FIG. 11) to perform an exposure control computation (e.g., an Auto Exposure (AE) computation). For example, the processor (e.g., the processor 320 of FIG. 3) may perform a computation of identifying a first exposure value (e.g., a brightness value), based on input pixel values. For example, the processor (e.g., the processor 320 of FIG. 3) may perform a computation of comparing the identified first exposure value and a second exposure value. For example, the processor (e.g., the processor 320 of FIG. 3) may create a control signal which changes at least one value among an aperture, exposure time, and sensitivity of a camera module (e.g., the camera module 180 of FIG. 2, the camera module 380 of FIG. 3), based on the difference between the first exposure value and the second exposure value.

According to an embodiment, the electronic device 1200 may process an operation of creating the first image 1290 and an operation of controlling a camera module (e.g., the camera module 1101 of FIG. 11) in parallel. For example, the processor (e.g., the processor 320 of FIG. 3) may perform an operation in which the pixel value 1212 of the first pixel line (e.g., the first pixel line 1121 of FIG. 11) is obtained preferentially to control the camera module (e.g., the camera module 1101 of FIG. 11), and may perform an operation in which pixel lines (e.g., the pixel value 1210 of the pixel lines 1120 of FIG. 11) are sequentially obtained to create the first image 1290.

Referring to FIG. 12, the electronic device 1200 may use the image sensor of the global shutter method to obtain the pixel values 1210. For example, the electronic device 1200 may obtain the pixel values 1212 of the first pixel line including sensor pixels corresponding to the region of interest (e.g., the region of interest 1111 of FIG. 11) and the second pixel values 1211 of the second pixel line not including sensor pixels corresponding to the region of interest (e.g., the region of interest 1111 of FIG. 11). For example, the electronic device 1200 may read out the pixel value 1212 of the first pixel line in preference to the second pixel values 1211 of the second pixel line. The pixel value 1212 of the first pixel line is read out in preference to the second pixel values 1211 of other pixel lines, thereby securing time for performing a computation in which the pixel value 1212 of the first pixel line is used to control the camera module (e.g., the camera module 1101 of FIG. 11). Therefore, when the camera module (e.g., the camera module 1101 of FIG. 11) obtains the second image, the AF control signal 1203 obtained based on the pixel value 1212 of the first pixel line may be used. In addition, when the camera module (e.g., the camera module 1101 of FIG. 11) obtains the second image, an exposure control signal obtained based on the pixel value 1212 of the first pixel line may be used. The second image may be an image obtained after the first image is obtained. The second image may include an image obtained using the pixel values 1220 obtained after the pixel values 1210 are obtained.

The operations in which the electronic device 1200 obtains the first mage may be analogously applied to the operations in which the electronic device 1200 obtains the second image. For example, the electronic device 1200 may perform an operation in which the pixel value 1222 of the first pixel line (e.g., the first pixel line 1121 of FIG. 11) is obtained preferentially to control the camera module (e.g., the camera module 1101 of FIG. 11), and may perform an operation in which the pixel value 1221 of pixel lines (e.g., the pixel lines 1120 of FIG. 11) are sequentially obtained to create the second image.

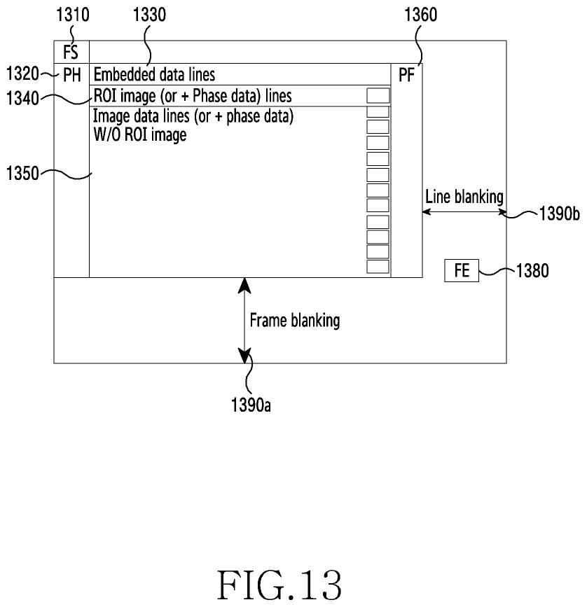

FIG. 13 is a drawing for explaining data output from an image sensor which obtains an image through a global shutter method, according to an embodiment of the disclosure.

Frame data including the pixel values 1210 and 1220 described above with reference to FIG. 12 may be shown in FIG. 13. The frame data of FIG. 13 may correspond to the frame data output from the computation unit 417 described above with reference to FIG. 4.

Referring to FIG. 13, according to an embodiment, the frame data may include a Frame Start (FS) 1310, a Pixel Head (PH) 1320, an embedded data line 1330, pixel data lines 1340 and 1350, a Pixel Frame (PF) 1360, a Frame End (FE) 1380, a frame blanking 1390a, and a line blanking 1390b, but the disclosure is not limited thereto. The frame data may include more components than those illustrated in FIG. 13, or the frame data may be composed of only few components. The frame data may be configured differently depending on a type and setting of an image sensor.

According to an embodiment, the frame data may include the FS 1310. For example, the FS 1310 may indicate that a new frame starts. For example, the FS 1310 may include an identifier for indicating a start point of the frame data.

According to an embodiment, the frame data may include the PH 1320. For example, the PH 1320 may include an identifier for indicating a start point of pixel values. For example, the PH 1320 may include an identifier for indicating a start of data lines.

According to an embodiment, the frame data may include the embedded data line 1330. For example, the embedded data line 1330 may include additional data related to a pixel value. For example, the embedded data line 1330 may include data on a capture environment (context). For example, the embedded data line 1330 may include metadata, timestamp, or state information of a frame. For example, the embedded data line 1330 may include information on a start and end of a coordinate of sensor pixels corresponding to a region of interest and/or information on a size of the region of interest. For example, the embedded data line 1330 may include information on whether phase data is included in data lines. For example, the embedded data line 1330 may include information on an order by which a pixel line corresponding to a first data line 1340 is disposed among a plurality of pixel lines constituting the image sensor.

According to an embodiment, the frame data may include the data lines 1340 and 1350. For example, the data lines 1340 and 1350 may include pixel values obtained from sensor pixels. For example, the data lines 1340 and 1350 may include pixel values obtained from the respective pixel lines on a line basis.

According to an embodiment, the frame data may include the first data line 1340 including pixel values obtained from a first pixel line (e.g., the first pixel line 1121 of FIG. 11). For example, the first data line 1340 may include a pixel value obtained from the first pixel line (e.g., the first pixel line 1121 of FIG. 11) including sensor pixels corresponding to a region of interest. For example, the first data line 1340 may include information on a distance between an object of interest and a camera module (e.g., the camera module 180 of FIG. 2, the camera module 380 of FIG. 3) related to the region of interest (e.g., the region of interest 1111 of FIG. 11). For example, the first data line 1340 may include phase data of the region of interest (e.g., the region of interest 1111 of FIG. 11). According to an embodiment, the frame data may include the second data line 1350 including pixel values obtained from second pixel lines. For example, the second data line 1350 may include a pixel value obtained from the second pixel lines not including sensor pixels corresponding to the region of interest. For example, the second data line 1350 may include phase data obtained from the sensor pixels.

According to an embodiment, in the frame, the first data line 1340 may be disposed in preference to the second data line 1350. For example, in order for the electronic device (e.g., the electronic device 1100 of FIG. 11) to perform a computation for controlling the camera module by using a pixel value obtained from a sensor pixel corresponding to a region of interest, the first data line 1340 may be disposed in preference to the second data line 1350.

According to an embodiment, the frame data may include the PF 1360. For example, the PF 1360 may include an identifier for indicating that a specific pixel value is included in part of the frame data. For example, the PF 1360 may include an identifier for indicating an end of the data lines 1340 and 1350.

According to an embodiment, the frame data may include the FE 1380. For example, the FE 1380 may include an identifier for indicating a last point of the frame data.

According to an embodiment, the frame data may include the frame blanking 1390a. For example, the frame data may include the frame blanking 1390a which is an inactive region between one piece of frame data and another piece of frame data.

According to an embodiment, the frame data may include the line blanking 1390b. For example, the frame data may include the line blanking 1390b which is an inactive region between data lines.

According to an embodiment, the electronic device (e.g., the electronic device 1100 of FIG. 11) may use frame data to control a camera module (e.g., the camera module 1101 of FIG. 11). For example, the electronic device (e.g., the electronic device 1100 of FIG. 11) may use pixel values obtained from the first data line to provide focus control and/or exposure control of the camera module (e.g., the camera module 1101 of FIG. 11).

According to an embodiment, the electronic device (e.g., the electronic device 1100 of FIG. 11) may use the frame data to obtain an image. For example, the electronic device (e.g., the electronic device 1100 of FIG. 11) may use pixel values from data lines included in the frame to reconfigure the image. For example, electronic device (e.g., the electronic device 1100 of FIG. 11) may use information on a location of the first data line 1340 to combine pixel values obtained from the first data line 1340 and pixel values obtained from the second data line 1350, thereby reconfiguring the image.

According to an embodiment, electronic device (e.g., the electronic device 1100 of FIG. 11) may process a computation of obtaining an image and a computation of controlling the camera module (e.g., the camera module 1101 of FIG. 11) in parallel. For example, the electronic device may perform a computation of controlling the camera module (e.g., the camera module 1101 of FIG. 11) by using the first data line 1340 disposed in preference to the second data line 1350, and may process in parallel a computation of creating an image by using a pixel value of the data lines 1340 and 1350 disposed sequentially.

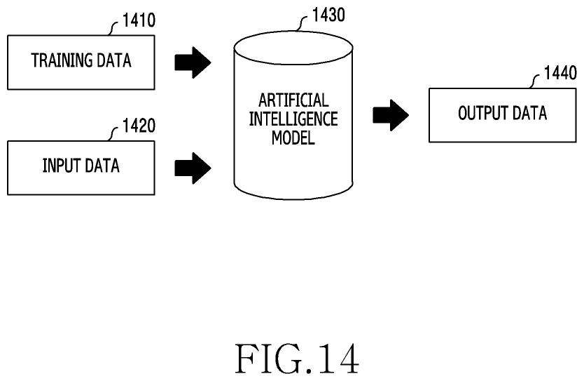

FIG. 14 is a drawing for explaining an artificial intelligence model used by an electronic device, according to an embodiment of the disclosure.

An artificial intelligence model 1430 of FIG. 14 may be built on the electronic device (e.g., the electronic device 200 of FIG. 2, the electronic device 101 of FIG. 3, the electronic device 1100 of FIG. 11) described above with reference to FIGS. 2, 3, and 11. The artificial intelligence model of FIG. 14 may be built on the electronic devices 102 and 104 and/or server 108 described above with reference to FIG. 1. The artificial intelligence model 1430 may be trained so that output data 1440 is output in response to input data 1420 being applied.

According to an embodiment, the artificial intelligence model 1430 may be trained to obtain information on an object. For example, the artificial intelligence model 1430 may be trained to identify an object included in an image of the input data 1420 to output information on the object as the output data 1440. For example, the artificial intelligence model 1430 may be trained to output information on a type of the object as the output data 1440. For example, the artificial intelligence model 1430 may be trained to output a result of identifying a primary object among the objects included in the image. For example, the artificial intelligence model 1430 may be trained to output information on a location of a region of interest corresponding to the primary object in the image. For example, the artificial intelligence model 1430 may be trained to output the information on the location of the region of interest by tracking the region of interest.

According to an embodiment, the artificial intelligence model 1430 may be trained to identify the object. For example, the artificial intelligence model 1430 may analyze an image of a plurality of objects input as training data 1410 to identify a feature of the objects from the image. The training data 1410 may include an image to which a label for the object is assigned. For example, the artificial intelligence model 1430 may use a plurality of layers to identify the feature of the objects. For example, the artificial intelligence model 1430 may use a filter for an edge, shape, and/or color of an object in the image to identify a feature of the object. For example, the artificial intelligence model 1430 may update a parameter of the artificial intelligence model 1430 such that a loss function representing a difference between the output data 1440 and the label included in the training data 1410 is minimized. For example, the artificial intelligence model 1430 may output a result of identifying an object included in the input data 1420 as the output data 1440, based on the identified feature of the object. For example, the artificial intelligence model 1430 may output a result of identifying a type of the object as the output data 1440.

According to an embodiment, the artificial intelligence model 1430 may be trained to identify a primary object and a secondary object. For example, the artificial intelligence model 1430 may identify the primary object and the secondary object, based on a result of identifying a type of the object. For example, the artificial intelligence model 1430 may identify the primary object and the secondary object among the identified objects, based on a priority of defined objects. For example, the artificial intelligence model 1430 may identify a person as the primary object and identify an animal and a car as the secondary object, based on a priority defined in the order of person, animal, and car. For example, the artificial intelligence model 1430 may identify a face as the primary object and identify a head and an upper body as the secondary object, based on a priority defined in the order of face, head, and upper body. For example, the artificial intelligence model 1430 may output information on the identified primary object and secondary object as the output data 1440.

According to an embodiment, the artificial intelligence model 1430 may be trained to set a region of interest. For example, the artificial intelligence model 1430 may be trained to set a region of interest in the identified primary object. For example, the artificial intelligence model 1430 may be trained to output information on a location (e.g., a coordinate) of the region of interest as the output data 1440.

According to an embodiment, the artificial intelligence model 1430 may be trained to track the region of interest. For example, the artificial intelligence model 1430 may be trained to output information on a location of a region of interest on a second image as the output data 1440, when information on a location of a region of interest on a first image is applied as the input data 1420. For example, the artificial intelligence model 1430 may be trained with the training data 1410 including information on a location of a region of interest (e.g., a center coordinate, a corner coordinate) at each of a plurality of images. For example, the artificial intelligence model 1430 may use the input training data 1410 to perform forward propagation, thereby updating a weight.

According to an embodiment, the artificial intelligence model 1430 may be validated by data including information on a location of a region of interest. For example, the artificial intelligence model 1430 may be validated by validation data including the information on the location of the region of interest (e.g., a center coordinate, a corner coordinate) with respect to each of a plurality of images. For example, the artificial intelligence model 1430 may use the validation data to perform back propagation, thereby updating the weight.

According to an embodiment, the electronic device may input information on a location (e.g., a coordinate) of the region of interest on the first image to the artificial intelligence model 1430. For example, the electronic device may input a center coordinate and/or corner coordinate of the region of interest on the first image.

According to an embodiment, the electronic device may obtain information on a location (e.g., a coordinate) of a region of interest on a second image from the artificial intelligence model 1430. For example, the electronic device may obtain a center coordinate and/or corner coordinate of the region of interest on the second image output from the artificial intelligence model 1430.

According to an embodiment, the electronic device may set the region of interest on the second image, based on the information on the location (e.g., the coordinate) of the region of interest on the second image obtained from the artificial intelligence model 1430. For example, the electronic device may identify the coordinate of the region of interest to set the region of interest on the second image, based on the center coordinate and/or corner coordinate of the region of interest on the second image output from the artificial intelligence model 1430.

According to an embodiment, at least one processor (e.g., the processor 320 of FIG. 3) may execute a neural network model as the artificial intelligence model 1430. For example, the neural network model may include a deep learning model which allows to perform a specific purpose operation, based on a result of learning training data. For example, the neural network model may include at least one of various types of neural network models such as a Convolution Neural Network (CNN), a Region with Convolution Neural Network (R-CNN), a Region Proposal Network (RPN), a Recurrent Neural Network (RNN), a Stacking-based deep Neural Network (S-DNN), a State-Space Dynamic Neural Network (S-SDNN), a deconvolution network, a Deep Belief Network (DBN), a Restricted Boltzmann Machine (RBM), a fully convolutional network, a (Long Short-Term Memory (LSTM) network, and a classification network. In addition to a hardware structure, the artificial intelligence model 1430 may include, additionally or alternatively, a software structure.

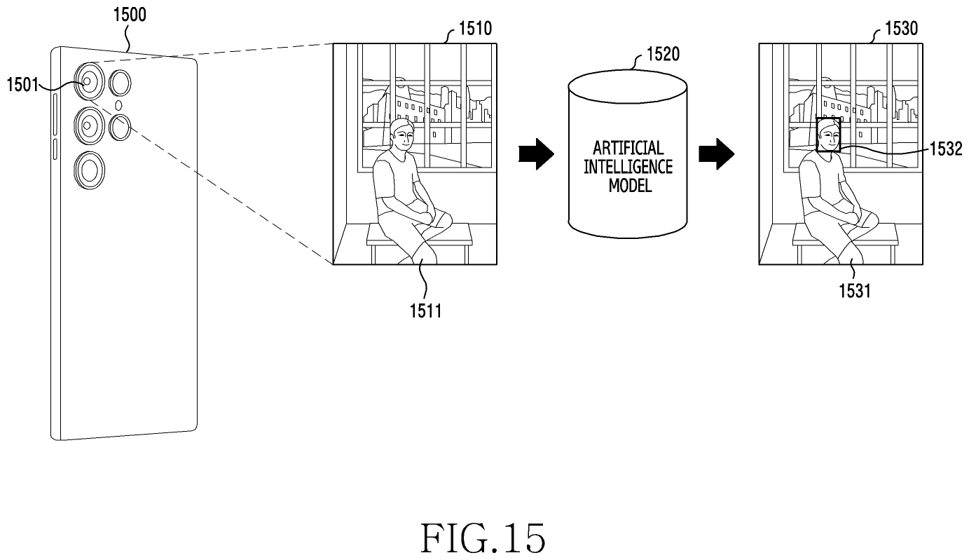

FIG. 15 is a drawing for explaining an operation in which an electronic device uses an artificial intelligence model to identify an object for a region of interest, according to an embodiment of the disclosure.

An artificial intelligence model 1520 may correspond to the artificial intelligence model 1430 described above with reference to FIG. 14. An electronic device 1500 of FIG. 15 may correspond to the electronic devices 101, 200, and 1100 described above with reference to FIGS. 2, 3, and 11. The artificial intelligence model 1520 of FIG. 15 may be built on the electronic devices 101, 200, and 1100 described above with reference to FIGS. 2, 3, and 11. The artificial intelligence model of FIG. 15 may be built on the electronic devices 102 and 104 and/or server 108 described above with reference to FIG. 1.

According to an embodiment, the electronic device 1500 may use a camera module 1501 to obtain a first image 1510. For example, the electronic device 1500 may obtain the first image 1510 including a person 1511, a window, and a building outside the window.

According to an embodiment, the electronic device 1500 may apply the first image 1510 to the artificial intelligence model 1520. For example, the electronic device 1500 may apply the first image 1510 to the artificial intelligence model 1520 trained to identify an object from the image. For example, the electronic device 1500 may apply the first image 1510 to the artificial intelligence model 1520 trained to identify a primary object. For example, the electronic device 1500 may apply the first image 1510 to the artificial intelligence model 1520 trained to set a region of interest to the primary object. For example, the electronic device 1500 may apply the first image 1510 to the artificial intelligence model 1520 trained to output a coordinate of the region of interest.

According to an embodiment, the artificial intelligence model 1520 may identify an object from the first image 1510. For example, the artificial intelligence model 1520 may identify the person 1511, the window, and the building outside the window from the input first image 1510.

According to an embodiment, the artificial intelligence model 1520 may identify the primary object from the first image 1510. For example, the artificial intelligence model 1520 may identify the person 1511 as the primary object among the person 1511, the window, and the buildings outside the window. For example, the artificial intelligence model 1520 may identify a face of the person 1511 as the primary object.

According to an embodiment, the artificial intelligence model 1520 may set the region of interest to the primary object. For example, the artificial intelligence model 1520 may set a region correspond to a person 1531 identified as the primary object to the region of interest. For example, the artificial intelligence model 1520 may set a region corresponding to a face 1532 of the person 1531 to the region of interest.

According to an embodiment, the artificial intelligence model 1520 may output a coordinate of the region of interest. For example, the artificial intelligence model 1520 may output the coordinate of the region of interest set to an image 1530. For example, the artificial intelligence model 1520 may output a corner coordinate and/or center coordinate of the region of interest. For example, the artificial intelligence model 1520 may output a corner coordinate and/or center coordinate of a region corresponding to the person 1531. For example, the artificial intelligence model 1520 may output a corner coordinate and/or center coordinate of a region corresponding to the face 1532.

According to an embodiment, the electronic device 1500 may control the camera module 1501, based on the region of interest. For example, the electronic device 1500 may provide focus control and/or exposure control of the camera module 1051, based on a pixel value obtained from the region of interest.

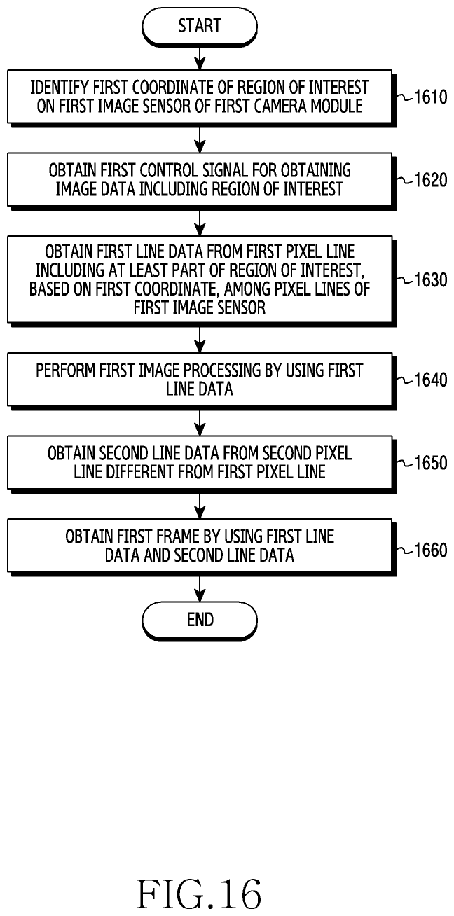

FIG. 16 is a flowchart of an operating method in which an electronic device obtains an image, according to an embodiment of the disclosure.

An operation of the electronic device of FIG. 16 (e.g., the electronic device 200 of FIG. 2) may be performed when a processor (e.g., the processor 220 of FIG. 2) performs a computation or controls a component of the electronic device (e.g., the electronic device 200 of FIG. 2). In embodiments described hereinafter, operations of the electronic device may be performed sequentially, but may not necessarily be performed sequentially. For example, orders of the operations may be changed, and at least two operations may be performed in parallel.

Referring to operation 1610, the electronic device according to an embodiment may identify a first coordinate of a region of interest on a first image sensor of a first camera module. For example, the electronic device may identify a corner coordinate of the region of interest and/or a center coordinate of the region of interest. For example, the electronic device may identify a coordinate of the region of interest, based on a received user input on a preview image. For example, the electronic device may identify the coordinate of the region of interest, based on an algorithm for setting the region of interest. For example, the electronic device may identify the coordinate of the region of interest from output data including the coordinate of the region of interest, output from an artificial intelligence model. For example, the electronic device may identify sensor pixels corresponding to the region of interest on the first image sensor. For example, the first camera module may obtain an image by using the image sensor described above with reference to FIGS. 8 to 10.

Referring to operation 1620, the electronic device according to an embodiment may obtain a first control signal for obtaining image data including a region of interest. For example, the processor may obtain the first control signal so that a camera module obtains a first frame. For example, the first control signal may include a reset time, an exposure time, and/or a read-out time of the image sensor.

Referring to operation 1630, the electronic device according to an embodiment may obtain first line data from a first pixel line including at least part of a region of interest, based on a first coordinate, among pixel lines of the first image sensor. For example, the electronic device may obtain the first line data described above with reference to FIG. 13 (e.g., the first line data 1340 of FIG. 13).

For example, as described above with reference to FIGS. 11 and 12, the electronic device may read out the pixel values 1212 of the first pixel line 1121 including first sensor pixels corresponding to a region of interest (e.g., the region of interest 1111 of FIG. 11) in preference to the second pixel values 1211 of other pixel lines not including the first sensor pixels corresponding to the region of interest (e.g., the region of interest 1111 of FIG. 11). For example, the electronic device may obtain the first line data including the pixel values of the first sensor pixels.

For example, the electronic device may obtain the first line data including a first tag for a region of interest. For example, the first tag may include a coordinate of the region of interest. For example, the first tag may include a corner coordinate and/or center coordinate of the region of interest.

For example, the electronic device may obtain the first line data including a second tag for a location of the first pixel line. For example, the second tag may include information on a location of a pixel line corresponding to the first line data. For example, the second tag may include information on the location of the first pixel line among the plurality of pixel lines.

Referring to operation 1640, the electronic device according to an embodiment may perform first image processing by using the first line data.

For example, the electronic device may obtain first pixel values corresponding to a region of interest, based on the first tag. For example, the electronic device may obtain a pixel value corresponding to the region of interest, based on a coordinate of the region of interest included in the first tag.

For example, the electronic device may control a focus of a camera module by using the first pixel values. For example, the electronic device may obtain distance data for a distance between the camera module and an object included in the region of interest by using the first pixel value, and may control the focus of the camera module, based on the distance data.

For example, the electronic device may control exposure of the camera module by using the first pixel values. For example, the electronic device may control an aperture, exposure time, and/or sensitivity of the camera module, based on identifying of brightness of the region of interest by using the first pixel values.

For example, the electronic device may apply the first pixel values to the artificial intelligence model to control the camera module, based on information on an object output from the artificial intelligence model. For example, the electronic device may control a focus of the camera module by using a coordinate of the region of interest, output from the artificial intelligence model. For example, the electronic device may control the aperture, exposure time, and/or sensitivity of the camera module, based on an exposure adjustment value of the region of interest, output from the artificial intelligence model.

Referring to operation 1650, the electronic device according to an embodiment may obtain second line data from a second pixel line different from the first pixel line. For example, the electronic device may obtain the second line data described above with reference to FIG. 13 (e.g., the second line data 1350 of FIG. 13).

For example, as described above with reference to FIGS. 11 and 12, the electronic device may sequentially read out line data including pixel values of pixel lines of the image sensor. For example, the electronic device may sequentially read out pixel values of the remaining pixel lines other than the first pixel line.

Referring to operation 1660, the electronic device according to an embodiment may obtain the first frame by using the first line data and the second line data. For example, the electronic device may obtain the first frame by combining pixel values of the first pixel line included in the first line data and pixel values of the second pixel line included in the second line data.

For example, the electronic device may perform second image processing to obtain the first frame, based on a second tag. For example, the electronic device may combine the pixel values of the first pixel line and the pixel values of the second pixel line, based on the second tag, to obtain the first frame for a location of the first pixel line.

For example, the electronic device may perform the second image processing to obtain the first frame, based on the first tag. For example, the electronic device may identify sensor pixels corresponding to a region of interest, based on the first tag. For example, the electronic device may identify a location of the first pixel line including the sensor pixels, based on the first tag. For example, the electronic device may create the first frame by combining the pixel values of the first pixel line and the pixel values of the second pixel line in accordance with the location of the first pixel line identified based on the first tag.

For example, the electronic device may adjust color of an image obtained from the camera module by using the first pixel values. For example, the electronic device may obtain information on the color of the region of interest by using the first pixel values. For example, the electronic device may adjust a channel value of defined color (e.g., red, green, blue), based on a defined color temperature and tint of the region of interest.

According to an embodiment, the electronic device may obtain a second frame, based on a result of performing the first image processing. For example, the electronic device may obtain the second frame, based on the camera module controlled using the first pixel values.

For example, the electronic device may obtain first distance data by using the first pixel values, and may control a focus of the camera module, based on the first distance data. For example, the electronic device may obtain the second frame, based on the focus of the controlled camera module.

For example, the electronic device may identify brightness of the region of interest by using the first pixel values. For example, the electronic device may control the aperture, exposure time, and/or sensitivity of the camera module, based on a result of comparing an exposure value of the region of interest and a defined exposure value. For example, the electronic device may obtain the second frame by using the controlled camera module.

For example, the electronic device may obtain the second frame, based on information on an object identified using the first pixel values. For example, the electronic device may obtain a coordinate of the region of interest, based on a result of identifying the object. For example, the electronic device may control a focus of the camera module, based on the coordinate of the region of interest. For example, the electronic device may obtain the second frame by using the camara module of which the focus is controlled.

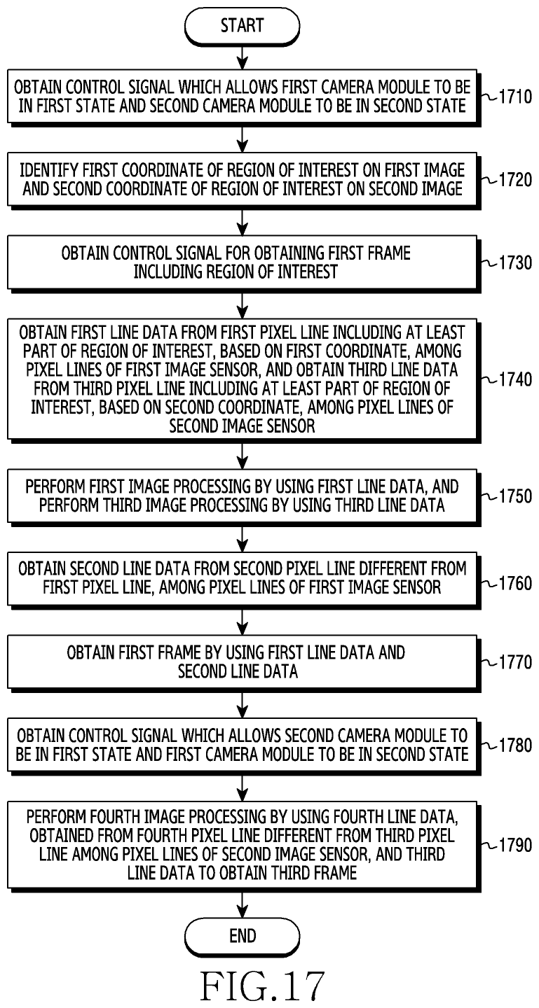

FIG. 17 is a flowchart of an operating method in which an electronic device obtains an image by using a plurality of camera modules, according to an embodiment of the disclosure.

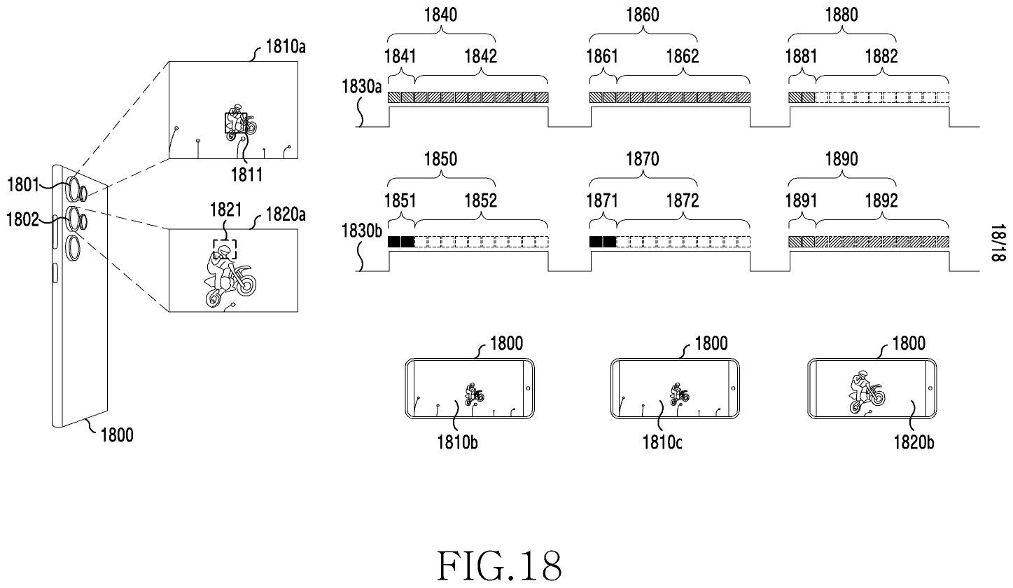

FIG. 18 is a drawing for explaining an operation in which an electronic device obtains an image by using a plurality of camera modules, according to an embodiment of the disclosure.

An operation of the electronic device of FIG. 17 (e.g., the electronic device 200 of FIG. 2) may be performed when a processor (e.g., the processor 220 of FIG. 2) performs a computation or controls a component of the electronic device (e.g., the electronic device 200 of FIG. 2). In embodiments described hereinafter, operations of the electronic device may be performed sequentially, but may not necessarily be performed sequentially. For example, orders of the operations may be changed, and at least two operations may be performed in parallel.

An electronic device 1800 of FIG. 18 may correspond to the electronic device 200 of FIG. 2 and the electronic device 101 of FIG. 3. The operation of the electronic device 1800 described with reference to FIG. 18 may be performed under the control of a processor (e.g., the processor 320 of FIG. 3). An image sensor included in a first camera module 1801 of FIG. 18 may correspond to the image sensor described above with reference to FIG. 11. An image sensor included in a second camera module 1802 of FIG. 18 may correspond to the image sensor described above with reference to FIG. 11.

Referring to FIG. 18, the electronic device 1800 according to an embodiment may include the first camera module 1801 and the second camera module 1802. The first camera module 1801 may obtain a first image 1810a in a range of a first field of view. That is, the first camera module 1801 may include a first lens module configured to have a first focal length. The second camera module 1802 may obtain a second image 1820a in a range of a second field of view. That is, the second camera module 1802 may include a second lens module configured to have a second focal length.

According to an embodiment, the electronic device 1800 may match an image pixel of a first image obtained using a first image sensor and an image pixel of a second image obtained using a second image sensor. For example, the electronic device 1800 may match coordinates of image pixels obtained by an image signal output from first and second sensor pixels mapped to each other. For example, the electronic device 1800 may match a first coordinate of the first image pixel corresponding to the first sensor pixel and a second coordinate of the second image pixel corresponding to the second sensor pixel.

According to an embodiment, the electronic device 1800 may set a first region of interest 1811 on the first image 1810a obtained using the first camera module 1801 and may set a second region of interest 1821 on the second image 1820a obtained using the second camera module 1802. For example, in response to receiving a user input for touching the first region of the first image 1810a, the electronic device 1800 may set the selected first region to the first region of interest 1811. For example, the electronic device 1800 may identify information (e.g., a corner coordinate, a center coordinate) on a location of the first region of interest 1811. For example, the electronic device 1800 may identify a coordinate of the first sensor pixel of a sensor of the first image 1810a corresponding to the first region of interest 1811. For example, the electronic device 1800 may obtain information (e.g., a corner coordinate, a center coordinate) on a location of the second region of interest 1821 corresponding to the second sensor pixel from a coordinate of the second sensor pixel.

According to an embodiment, the electronic device 1800 may use the first camera module 1801 and/or the second camera module 1802 to obtain at least one frame. For example, the electronic device 1800 may use the first camera module 1801 to obtain a first frame 1810b. For example, the electronic device 1800 may use the first camera module 1801 to obtain a second frame 1810c. For example, the electronic device 1800 may use the second camera module 1802 to obtain a third frame 1820b. For example, the electronic device 1800 may use line data 1840 and 1860 obtained using the first camera module 1801 to obtain the first frame 1810b and the second frame 1810c. For example, the electronic device 1800 may use line data 1890 obtained using the second camera module 1802 to obtain the third frame 1820b.

Referring to operation 1710, the electronic device 1800 according to an embodiment may obtain a control signal which allows the first camera module 1801 to be in a first state and the second camera module 1802 to be in a second state. For example, the first state may include a state of obtaining and storing an image. For example, the second state may include a standby state or a state of obtaining only pixel values of some sensor pixels.

For example, the electronic device 1800 may drive a camera application to obtain a control signal (1830a, 1830b) which drives the first camera module 1801 and the second camera module 1802. For example, the electronic device 1800 may obtain a control signal including a camera open command. For example, the electronic device 1800 may provide the control signal (1830a, 1830b) to the first camera module 1801 and the second camera module 1802 so that the first camera module 1801 and the second camera module 1802 create image data.

Referring to operation 1720, the electronic device 1800 according to an embodiment may identify the first coordinate of the first region of interest 1811 on the first image 1810a and the second coordinate of the second region of interest 1821 on the second image 1820a. The first image 1810a and the second image 1820a may be matched in coordinates. For example, the electronic device 1800 may identify the first coordinate of the first region of interest 1811 in response to receiving a user input on the first image 1810a. For example, the electronic device 1800 may identify the first coordinate of the first region of interest 1811 corresponding to a primary object identified from the first image 1810a. For example, the electronic device 1800 may identify the second coordinate of the second region of interest 1821, based on identifying the first coordinate of the first region of interest 1811.

Referring to operation 1730, the electronic device 1800 according to an embodiment may obtain a control signal for obtaining the first frame 1810b.

For example, the electronic device 1800 may obtain a control signal which controls a focus of the first camera module 1801 so that the first region of interest 1811 is in focus. For example, the obtained control signal may control an aperture, exposure time, and/or sensitivity of the first camera module 1801 such that an exposure value of the first region of interest 1811 corresponds to a defined exposure value.

For example, the electronic device 1800 may obtain a control signal which controls a focus of the second camera module 1802 so that the second region of interest 1821 is in focus. For example, the obtained control signal may control an aperture, exposure time, and/or sensitivity of the second camera module 1802 such that an exposure value of the second region of interest 1821 corresponds to a defined exposure value.

Referring to operation 1740, the electronic device 1800 according to an embodiment may obtain first line data 1841 and 1861 from the first pixel line of the first camera module 1801, and may obtain third line data 1851 and 1871 from the third pixel line of the second camera module 1802. The first pixel line may include a pixel line including sensor pixels corresponding to the first region of interest 1811. The third pixel line may include a pixel line including sensor pixels corresponding to the second region of interest 1821.

For example, the electronic device 1800 may control the first camera module 1801 to obtain the first line data 1841 and 1861 in preference to second line data 1842 and 1862. For example, the electronic device 1800 may obtain the first line data 1841 and 1861 including a tag for a location of the first pixel line.

For example, the electronic device 1800 may control the second camera module 1802 to obtain only the third line data 1851 and 1871 from line data 1850 and 1870. For example, the electronic device 1800 may obtain the third line data 1851 and 1871 including a tag for a location of a second region of interest from the line data 1850 and 1870. For example, the electronic device 1800 may obtain only a pixel value of the third line data 1851 and 1871 from the line data 1850 and 1870. For example, the electronic device 1800 may provide control not to obtain fourth data 1852 and 1872 from the line data 1850 and 1870. For example, the electronic device 1800 may obtain only a pixel value corresponding to the second region of interest 1821 from the third line data 1851 and 1871.

Referring to operation 1750, the electronic device 1800 according to an embodiment may perform first image processing by using the first line data 1841 and 1861, and may perform third image processing by using the third line data 1851 and 1871.

For example, the electronic device 1800 may use a pixel value corresponding to the first region of interest 1811 included in the first line data 1841 and 1861 to provide focus control and/or exposure control of the first camera module 1801. For example, the electronic device 1800 may use a phase difference identified from the pixel value corresponding to the first region of interest 1811 to control a lens unit of the first camera module 1801. For example, the electronic device 1800 may use an exposure value identified from the pixel value corresponding to the first region of interest 1811 to control an aperture, exposure time, and/or sensitivity of the first camera module 1801.

For example, the electronic device 1800 may use a pixel value corresponding to the second region of interest 1821 included in the third line data 1851 and 1871 to provide focus control and/or exposure control of the second camera module 1802. For example, the electronic device 1800 may use a phase difference identified from the pixel value corresponding to the second region of interest 1821 to control a lens unit of the second camera module 1802. For example, the electronic device 1800 may use an exposure value identified from the pixel value corresponding to the second region of interest 1821 to control an aperture, exposure time, and/or sensitivity of the second camera module 1802.

Referring to operation 1760, the electronic device 1800 according to an embodiment may obtain the second line data 1842 and 1862 from the second pixel line of the first image sensor included in the first camera module 1801. The second pixel line may include a pixel line not including a sensor pixel corresponding to the first region of interest 1811. For example, the electronic device may sequentially read out pixel values of pixel lines of the first image sensor to obtain the second line data 1842 and 1862.

Referring to operation 1770, the electronic device 1800 according to an embodiment may use the first line data 1841 and the second line data 1842 to obtain the first frame. For example, the electronic device may combine pixel values of a first pixel line included in the first line data 1841 and pixel values of a second pixel line included in the second line data 1842 to obtain the first frame 1810b. For example, the electronic device may combine the pixel values of the first pixel line and the pixel values of the second pixel line, based on a tag for a location of the first pixel line, to create the first frame 1810b.

For example, the electronic device may use the first pixel values to adjust color of the first frame 1810b. For example, the electronic device may use the first pixel values to obtain information on color of the first region of interest 1811. For example, the electronic device may adjust a channel value of defined color (e.g., red, green, blue), based on a defined color temperature and tint of the first region of interest 1811.

According to an embodiment, the electronic device 1800 may obtain the second frame 1810c after the first frame 1810b is obtained. For example, the electronic device 1800 may obtain the second frame 1810c, based on a result of the first image processing of the operation 1750. For example, the electronic device 1800 may use a focus of the first camera module 1801 controlled based on the first image processing to obtain the second frame 1810c. For example, the electronic device 1800 may use an aperture, exposure time, and/or sensitivity of the first camera module 1801 controlled based on the first image processing to obtain the second frame 1810c.

According to an embodiment, the electronic device 1800 may obtain a pixel value of a sensor pixel corresponding to the second region of interest 1821 from the second camera module 1802, based on a result of third image processing. For example, the electronic device 1800 may obtain the third line data 1871 including only a pixel value corresponding to the second region of interest 1821.

According to an embodiment, the electronic device 1800 may repeat at least one of the operations 1720 to 1770 to obtain the second frame. Redundant description will be omitted.

Referring to operation 1780, the electronic device 1800 according to an embodiment may obtain a control signal which allows the first camera module 1801 to be in the second state and the second camera module 1802 to be in the first state. For example, the first state may include the state of obtaining and storing the image. For example, the second state may include the standby state or the state of obtaining only pixel values of some sensor pixels. The electronic device 1800 may switch operations of the first camera module 1801 and second camera module 1802.

Referring to operation 1790, the electronic device 1800 according to an embodiment may obtain the third frame 1820b by using the line data 1890 obtained using the second camera module 1802. For example, the electronic device 1800 may use third line data 1891 and fourth line data 1892 to obtain the third frame 1820b. For example, the electronic device may sequentially read out pixel values of pixel lines of the second image sensor to obtain the fourth line data 1892. The fourth line data 1892 may be obtained from fourth pixel line not including the sensor pixel corresponding to the second region of interest 1821.

For example, the electronic device may combine pixel values of the third pixel line included in the third line data 1891 and pixel values of the fourth pixel line included in the fourth line data 1892 to obtain the third frame 1820b. For example, the electronic device may combine the pixel values of the third pixel line and the pixel values of the fourth pixel line, based on a tag for a location of the third pixel line, to create the third frame 1820b.

For example, the electronic device 1800 may use the third pixel values to adjust color of the third frame 1820b. For example, the electronic device may use the third pixel values to obtain information on color of the second region of interest 1821. For example, the electronic device 1800 may adjust a channel value of defined color (e.g., red, green, blue), based on a defined color temperature and tint of the region of interest 1821.

According to an embodiment, the electronic device 1800 may display the third frame 1820b. For example, the electronic device 1800 may display the third frame 1820b, after the first frame 1810b and the second frame 1810c are displayed.

The electronic device 1800 according to an embodiment may control the first camera module 1801 to obtain line data 1880. For example, the electronic device 1800 may control the first camera module 1801 to obtain only first line data 1881. For example, the electronic device 1800 may control the first camera module 1801 not to obtain second line data 1882. For example, the electronic device 1800 may obtain the first line data 1881 including a tag for a location of a first region of interest.

Referring to FIGS. 17 and 18, the electronic device 1800 may perform a computation of controlling a camera module for each frame by using a pixel value obtained from a region of interest, thereby obtaining a frame in which a focus, exposure, and color are maintained even when the camera module for obtaining an image is switched. In addition, the electronic device may not initiate driving of a camera to be switched even when the camera module is switched, thereby providing a seamless smooth image.

Advantages acquired in the disclosure are not limited to the aforementioned advantages, and other advantages not mentioned herein may be clearly understood by those skilled in the art to which the disclosure pertains from the following descriptions.

An electronic device according to an embodiment (e.g., the electronic device 1100 of FIG. 11) may include a first camera module (e.g., the camera module 1101 of FIG. 11) including a first image sensor (e.g., the image sensor 383 of FIG. 3). The electronic device (e.g., the electronic device 1100 of FIG. 11) may include at least one processor (e.g., the processor 320 of FIG. 3) including a processing circuit. The electronic device (e.g., the electronic device 1100 of FIG. 11) may include memory (e.g., the memory 330 of FIG. 3) storing instructions. The electronic device (e.g., the electronic device 1100 of FIG. 11) may identify a first coordinate of a region of interest (e.g., the region of interest 1111 of FIG. 11) on the first image sensor (e.g., the image sensor 383 of FIG. 3). The electronic device (e.g., the electronic device 1100 of FIG. 11) may obtain a first control signal (e.g., the control signal 1201 of FIG. 12) for obtaining image data including the region of interest (e.g., the region of interest 1111 of FIG. 11). The electronic device (e.g., the electronic device 1100 of FIG. 11) may obtain first line data (e.g., the pixel value 1212 of FIG. 12) from a first pixel line (e.g., the first pixel line 1121 of FIG. 11) including at least part of the region of interest (e.g., the region of interest 1111 of FIG. 11), based on the first coordinate, among pixel lines (e.g., the pixel lines 1121 of FIG. 11) of the first image sensor (e.g., the image sensor 383 of FIG. 3), in response to the first control signal (e.g., the control signal 1201 of FIG. 12). The electronic device (e.g., the electronic device 1100 of FIG. 11) may perform first image processing by using the first line data (e.g., the pixel value 1212 of FIG. 12). The electronic device (e.g., the electronic device 1100 of FIG. 11) may obtain second line data (e.g., the second pixel values 1211 of FIG. 12) from a second pixel line different from the first pixel line among the pixel lines of the first image sensor. The electronic device (e.g., the electronic device 1100 of FIG. 11) may perform second image processing by using the first line data (e.g., the pixel value 1212 of FIG. 12) and the second line data (e.g., the second pixel values 1211 of FIG. 12) to obtain a first frame (e.g., the first image 1290 of FIG. 12).

According to an embodiment, the electronic device (e.g., the electronic device 1100 of FIG. 11) may expose all pixel lines (e.g., the pixel lines 1120 of FIG. 11) of the first image sensor for a first time duration at a first timing in response to the first control signal (e.g., the control signal 1201 of FIG. 12). The electronic device (e.g., the electronic device 1100 of FIG. 11) may obtain line data (e.g., the pixel values 1210 of FIG. 12) sequentially from the pixel lines (e.g., the pixel lines 1120 of FIG. 11) of the first image sensor.

According to an embodiment, the electronic device (e.g., the electronic device 1100 of FIG. 11) may obtain the first line data (e.g., the first line data 1340) including a first tag for the region of interest (e.g., the region of interest 1111 of FIG. 11). The electronic device (e.g., the electronic device 1100 of FIG. 11) may obtain first pixel values corresponding to the region of interest (e.g., the region of interest 1111 of FIG. 11), based on the first tag. The electronic device (e.g., the electronic device 1100 of FIG. 11) may perform the first image processing (e.g., the focus control computation 1202 of FIG. 12) by using the first pixel values. The electronic device (e.g., the electronic device 1100 of FIG. 11) may obtain a second frame, based on a result of performing the first image processing (e.g., the focus control computation 1202 of FIG. 12).

According to an embodiment, the electronic device (e.g., the electronic device 1100 of FIG. 11) may obtain the first line data (e.g., the first line data 1340 of FIG. 13) including a second tag for a location of the first pixel line (e.g., the first pixel line 1121 of FIG. 11) among the pixel lines (e.g., the pixel lines 1120 of FIG. 11) of the first image sensor. The electronic device (e.g., the electronic device 1100 of FIG. 11) may perform the second image processing to obtain the first frame (e.g., the first image 1290 of FIG. 12), based on the second tag.

According to an embodiment, the electronic device (e.g., the electronic device 1100 of FIG. 11) may control a lens module (e.g., the lens unit 381 of FIG. 3) of the first camera module (e.g., the camera module 1101 of FIG. 11) for the region of interest by using the first line data (e.g., the pixel value 1212 of FIG. 12), thereby performing an auto focus control function.

According to an embodiment, the electronic device (e.g., the electronic device 1100 of FIG. 11) may obtain first pixel values of the region of interest (e.g., the region of interest 1111 of FIG. 11) from the first line data (e.g., the pixel value 1212 of FIG. 12). The electronic device (e.g., the electronic device 1100 of FIG. 11) may identify brightness of the region of interest (e.g., the region of interest 1111 of FIG. 11), based on the first pixel values. The electronic device (e.g., the electronic device 1100 of FIG. 11) may control an exposure time of the first image sensor, based on the brightness of the region of interest (e.g., the region of interest 1111 of FIG. 11), to obtain a second frame.

According to an embodiment, the electronic device (e.g., the electronic device 1100 of FIG. 11) may obtain first pixel values of the region of interest (e.g., the region of interest 1111 of FIG. 11) from the first line data (e.g., the pixel value 1212 of FIG. 12). The electronic device (e.g., the electronic device 1100 of FIG. 11) may obtain information on color of the region of interest (e.g., the region of interest 1111 of FIG. 11), based on the first pixel values. The electronic device (e.g., the electronic device 1100 of FIG. 11) may adjust color of the first frame (e.g., the first image 1290 of FIG. 12), based on the information on the color of the region of interest (e.g., the region of interest 1111 of FIG. 11).

According to an embodiment, the electronic device (e.g., the electronic device 1100 of FIG. 11) may define a first color temperature and a first tint, based on the information on the color of the region of interest (e.g., the region of interest 1111 of FIG. 11). The electronic device (e.g., the electronic device 1100 of FIG. 11) may adjust the color of the first frame (e.g., the first image 1290 of FIG. 12), based on the first color temperature and the first tint.

According to an embodiment, the electronic device (e.g., the electronic device 1100 of FIG. 11) may obtain first pixel values of the region of interest (e.g., the region of interest 1111 of FIG. 11) from the first line data (e.g., the pixel value 1212 of FIG. 12). The electronic device (e.g., the electronic device 1100 of FIG. 11) may apply the first pixel values to an artificial intelligence model (e.g., the artificial intelligence model 1430 of FIG. 13) which identifies an object from an image to obtain information (e.g., the output data 1440 of FIG. 14) on the object output from the artificial intelligence model (e.g., the artificial intelligence model 1430 of FIG. 14). The electronic device (e.g., the electronic device 1100 of FIG. 11) may obtain a second frame, based on the information (e.g., the output data 1440 of FIG. 14) on the object.

According to an embodiment, the electronic device (e.g., the electronic device 1100 of FIG. 11) may further include a second camera module (e.g., the second camera module 1802 of FIG. 18) including a second image sensor. The electronic device (e.g., the electronic device 1100 of FIG. 11) may obtain a second control signal which allows the first camera module (e.g., the first camera module 1801 of FIG. 18) to be a first state and the second camera module (e.g., the second camera module 1802 of FIG. 18) to be a second state. The electronic device (e.g., the electronic device 1100 of FIG. 11) may identify a second coordinate of the region of interest (e.g., the second region of interest 1821 of FIG. 18) on the second image sensor. The electronic device (e.g., the electronic device 1100 of FIG. 11) may obtain third line data (e.g., the third line data 1851 of FIG. 18) from a third pixel line including at least part of the region of interest (e.g., the second region of interest 1821 of FIG. 18), based on the second coordinate among pixel lines of the second image sensor, in response to the second control signal. The electronic device (e.g., the electronic device 1100 of FIG. 11) may perform third image processing (e.g., the focus control computation 1202 of FIG. 12) by using the third line data (e.g., the third line data 1851 of FIG. 18). The electronic device (e.g., the electronic device 1100 of FIG. 11) may obtain a third control signal which allows the second camera module (e.g., the second camera module 1802 of FIG. 18) to be in the first state and the first camera module (e.g., the first camera module 1801 of FIG. 18) to be in the second state. The electronic device (e.g., the electronic device 1100 of FIG. 11) may perform fourth image processing by using the third line data (e.g., the third line data 1891 of FIG. 18) and fourth line data (e.g., the fourth line data 1892 of FIG. 18) obtained from a fourth pixel line different from the third pixel line among the pixel lines of the second image sensor to obtain a third frame, in response to the third control signal. The electronic device (e.g., the electronic device 1100 of FIG. 11) may display the third frame (e.g., the third frame 1820b of FIG. 18).

An operating method of an electronic device according to an embodiment may include identifying a first coordinate of a region of interest on a first image sensor of a first camera module. The operating method may include obtaining a first control signal for obtaining image data including the region of interest. The operating method may include obtaining first line data from a first pixel line including at least part of the region of interest, based on the first coordinate, among pixel lines of the first image sensor, in response to the first control signal. The operating method may include performing first image processing by using the first line data. The operating method may include obtaining second line data from a second pixel line different from the first pixel line among the pixel lines of the first image sensor. The operating method may include performing second image processing by using the first line data and the second line data to obtain a first frame.

According to an embodiment, the obtaining of the first line data may include obtaining the first line data including a first tag for the region of interest. The performing of the first image processing may include obtaining first pixel values corresponding to the region of interest, based on the first tag. The performing of the first image processing may include performing the first image processing by using the first pixel values. The operating method may include obtaining a second frame, based on a result of performing the first image processing.

According to an embodiment, the obtaining of the first line data may include obtaining the first line data including a second tag for a location of the first pixel line among the pixel lines of the first image sensor. The obtaining of the first frame may include performing the second image processing, based on the second tag, to obtain the first frame.

According to an embodiment, the operating method may include controlling a lens module of the first camera module for the region of interest by using the first line data to perform an auto focus control function.

According to an embodiment, the performing of the first image processing may include obtaining first pixel values of the region of interest from the first line data. The performing of the first image processing may include identifying brightness of the region of interest, based on the first pixel values. The operating method may include controlling an exposure time of the first image sensor, based on the brightness of the region of interest, to obtain a second frame.

According to an embodiment, the performing of the first image processing may include obtaining first pixel values of the region of interest from the first line data. The performing of the first image processing may include obtaining information on color of the region of interest, based on the first pixel values. The obtaining of the first frame may include adjusting color of the first frame, based on the information on the color of the region of interest.

According to an embodiment, the performing of the first image processing may include defining a first color temperature and a first tint, based on the information on the color of the region of interest. The obtaining of the first frame may include adjusting the color of the first frame, based on the first color temperature and the first tint.

According to an embodiment, the performing of the first image processing may include obtaining first pixel values of the region of interest from the first line data. The performing of the first image processing may include applying the first pixel values to an artificial intelligence model which identifies an object from an image to obtain information on the object output from the artificial intelligence model. The operating method may include obtaining a second frame, based on the information on the object.

According to an embodiment, the identifying of the first coordinate may include obtaining a second control signal which allows the first camera module to be in a first state and the second camera module to be in a second state. The identifying of the first coordinate may include identifying a second coordinate of the region of interest on the second image sensor. The operating method may include obtaining third line data from a third pixel line including at least part of the region of interest, based on the second coordinate among pixel lines of the second image sensor, in response to the second control signal. The operating method may include performing third image processing by using the third line data. The operating method may include obtaining a third control signal which allows the second camera module to be in the first state and the first camera module to be in the second state. The operating method may include performing fourth image processing by using the third line data and fourth line data obtained from a fourth pixel line different from the third pixel line among the pixel lines of the second image sensor to obtain a third frame, in response to the third control signal. The operating method may include displaying the third frame.

A computer readable non-transitory recording medium in which instructions for controlling an electronic device according to an embodiment are stored may include an instruction for identifying a first coordinate of a region of interest on a first image sensor of a first camera module. The recording medium may include an instruction for obtaining a first control signal for obtaining image data including the region of interest. The recording medium may include an instruction for obtaining first line data from a first pixel line including at least part of the region of interest, based on the first coordinate, among pixel lines of the first image sensor, in response to the first control signal. The recording medium may include an instruction for performing first image processing by using the first line data. The recording medium may include an instruction for obtaining second line data from a second pixel line different from the first pixel line among the pixel lines of the first image sensor. The recording medium may include an instruction for performing second image processing by using the first line data and the second line data to obtain a first frame.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first camera including a first image sensor;
at least one processor including a processing circuit; and
memory storing instructions,
wherein the at least one processor individually or collectively executes the instructions, causing the electronic device to:
identify a first coordinate of a region of interest on the first image sensor,
obtain a first control signal for obtaining image data including the region of interest,
obtain first line data from a first pixel line including at least part of the region of interest, based on the first coordinate, among pixel lines of the first image sensor, in response to the first control signal,
perform first image processing by using the first line data,
obtain second line data from a second pixel line different from the first pixel line among the pixel lines of the first image sensor, and
perform second image processing by using the first line data and the second line data to obtain a first frame.

2. The electronic device of claim 1, wherein the at least one processor individually or collectively executes the instructions, further causing the electronic device to:
expose all pixel lines of the first image sensor for a first time duration at a first timing in response to the first control signal; and
obtain line data sequentially from the pixel lines of the first image sensor.

3. The electronic device of claim 1, wherein the at least one processor individually or collectively executes the instructions, further causing the electronic device to:
obtain the first line data including a first tag for the region of interest;
obtain first pixel values corresponding to the region of interest, based on the first tag;
perform the first image processing by using the first pixel values; and
obtain a second frame, based on a result of performing the first image processing.

4. The electronic device of claim 1, wherein the at least one processor individually or collectively executes the instructions, further causing the electronic device to:
obtain the first line data including a second tag for a location of the first pixel line among the pixel lines of the first image sensor; and
perform the second image processing, based on the second tag, to obtain the first frame.

5. The electronic device of claim 1, wherein the at least one processor individually or collectively executes the instructions, further causing the electronic device to control a lens of the first camera for the region of interest by using the first line data to perform an auto focus control function.

6. The electronic device of claim 1, wherein the at least one processor individually or collectively executes the instructions, further causing the electronic device to:
obtain first pixel values of the region of interest from the first line data;
identify brightness of the region of interest, based on the first pixel values; and
control an exposure time of the first image sensor, based on the brightness of the region of interest, to obtain a second frame.

7. The electronic device of claim 1, wherein the at least one processor individually or collectively executes the instructions, further causing the electronic device to:
obtain first pixel values of the region of interest from the first line data;
obtain information on color of the region of interest, based on the first pixel values; and
adjust color of the first frame, based on the information on the color of the region of interest.

8. The electronic device of claim 7, wherein the at least one processor individually or collectively executes the instructions, further causing the electronic device to:
define a first color temperature and a first tint, based on the information on the color of the region of interest; and
adjust the color of the first frame, based on the first color temperature and the first tint.

9. The electronic device of claim 1, wherein the at least one processor individually or collectively executes the instructions, further causing the electronic device to:
obtain first pixel values of the region of interest from the first line data;
apply the first pixel values to an artificial intelligence model which identifies an object from an image to obtain information on the object output from the artificial intelligence model; and
obtain a second frame, based on the information on the object.

10. The electronic device of claim 1, further comprising:
a second camera including a second image sensor,
wherein the at least one processor individually or collectively executes the instructions, further causing the electronic device to:
obtain a second control signal which allows the first camera to be in a first state and the second camera to be in a second state,
identify a second coordinate of the region of interest on the second image sensor,
obtain third line data from a third pixel line including at least part of the region of interest, based on the second coordinate among pixel lines of the second image sensor, in response to the second control signal,
perform third image processing by using the third line data,
obtain a third control signal which allows the second camera to be in the first state and the first camera to be in the second state,
perform fourth image processing by using the third line data and fourth line data obtained from a fourth pixel line different from the third pixel line among the pixel lines of the second image sensor to obtain a third frame, in response to the third control signal, and
display the third frame.

11. A method performed by an electronic device, the method comprising:
identifying a first coordinate of a region of interest on a first image sensor of a first camera;
obtaining a first control signal for obtaining image data including the region of interest;
obtaining first line data from a first pixel line including at least part of the region of interest, based on the first coordinate, among pixel lines of the first image sensor, in response to the first control signal;
performing first image processing by using the first line data;
obtaining second line data from a second pixel line different from the first pixel line among the pixel lines of the first image sensor; and
performing second image processing by using the first line data and the second line data to obtain a first frame.

12. The method of claim 11,
wherein the obtaining of the first line data comprises obtaining the first line data including a first tag for the region of interest,
wherein the performing of the first image processing comprises:
obtaining first pixel values corresponding to the region of interest, based on the first tag, and
performing the first image processing by using the first pixel values, and
wherein the method further comprises obtaining a second frame, based on a result of performing the first image processing.

13. The method of claim 11,
wherein the obtaining of the first line data comprises obtaining the first line data including a second tag for a location of the first pixel line among the pixel lines of the first image sensor, and
wherein the obtaining of the first frame comprises performing the second image processing, based on the second tag, to obtain the first frame.

14. The method of claim 11, further comprising controlling a lens of the first camera for the region of interest by using the first line data to perform an auto focus control function.

15. The method of claim 11,
wherein the performing of the first image processing comprises:
obtaining first pixel values of the region of interest from the first line data, and
identifying brightness of the region of interest, based on the first pixel values, and
wherein the method further comprises controlling an exposure time of the first image sensor, based on the brightness of the region of interest, to obtain a second frame.

16. The method of claim 11,
wherein the performing of the first image processing comprises:
obtaining first pixel values of the region of interest from the first line data, and
obtaining information on color of the region of interest, based on the first pixel values, and
wherein the obtaining of the first frame comprises adjusting color of the first frame, based on the information on the color of the region of interest.

17. The method of claim 16,
wherein the performing of the first image processing further comprises defining a first color temperature and a first tint, based on the information on the color of the region of interest, and
wherein the obtaining of the first frame further comprises adjusting the color of the first frame, based on the first color temperature and the first tint.

18. The method of claim 11,
wherein the performing of the first image processing comprises:
obtaining first pixel values of the region of interest from the first line data, and
applying the first pixel values to an artificial intelligence model which identifies an object from an image to obtain information on the object output from the artificial intelligence model, and
wherein the method further comprises obtaining a second frame, based on the information on the object.

19. The method of claim 11,
wherein the identifying of the first coordinate comprises:
obtaining a second control signal which allows the first camera to be in a first state and a second camera to be in a second state; and
identifying a second coordinate of the region of interest on a second image sensor of the second camera, and
wherein the method further comprises:
obtaining third line data from a third pixel line including at least part of the region of interest, based on the second coordinate among pixel lines of the second image sensor, in response to the second control signal,
performing third image processing by using the third line data,
obtaining a third control signal which allows the second camera to be in the first state and the first camera to be in the second state,
performing fourth image processing by using the third line data and fourth line data obtained from a fourth pixel line different from the third pixel line among the pixel lines of the second image sensor to obtain a third frame, in response to the third control signal, and
displaying the third frame.

20. A computer-readable non-transitory recording medium in which instructions for controlling an electronic device are stored, the instructions when executed by one or more processors of an electronic device individually or collectively, cause the electronic device to perform operations, the operations comprising:
identifying a first coordinate of a region of interest on a first image sensor of a first camera;
obtaining a first control signal for obtaining image data including the region of interest;
obtaining first line data from a first pixel line including at least part of the region of interest, based on the first coordinate, among pixel lines of the first image sensor, in response to the first control signal;
performing first image processing by using the first line data;
obtaining second line data from a second pixel line different from the first pixel line among the pixel lines of the first image sensor; and
performing second image processing by using the first line data and the second line data to obtain a first frame.
